(19) United States
(12) Patent Application Publication
(10) Pub. No.: US 2024/0185349 A1
(43) Pub. Date: Jun. 6, 2024

(54) SYSTEMS AND METHODS FOR AGGREGATING ENVIRONMENTAL, SOCIAL, AND GOVERNANCE (ESG) IMPACT DATA AND SUSTAINABLE PRODUCT DATA FOR SUSTAINABLE INVESTMENT PORTFOLIOS

(71) Applicant: Physis Investment Inc., Boston, MA (US)

(72) Inventor: Stefania Di Bartolomeo, Boston, MA (US)

(73) Assignee: Physis Investment Inc., Boston, MA (US)

(21) Appl. No.: 17/969,706

(22) Filed: Oct. 20, 2022

(51) Int. Cl. G06Q 40/06

(52) U.S. Cl. CPC G06Q 40/06

(57) ABSTRACT

A method and system for aggregating environmental, social, and governance (ESG) impact data and sustainable product data for sustainable investment portfolios are described. The system includes one or more external data sources, a computing device, a database or repository, and a sustainable wealth management platform. The computing device includes at least an engine, where the engine includes at least one algorithm. The engine is configured to collect ESG impact data and sustainable product data from the one or more external data sources, aggregate the ESG impact data and the sustainable product data, transfer the aggregated data to a sustainable wealth management platform, and provide access to a user to interact with the sustainable wealth management platform via numerous tools to track, measure, and understand an impact of an investment in a sustainable investment portfolio.

### FIELD OF THE EMBODIMENTS

The field of the invention and its embodiments relate to systems and methods for aggregating environmental, social, and governance (ESG) impact data and sustainable product data for sustainable investment portfolios.

### BACKGROUND OF THE EMBODIMENTS

Traditionally, financial investing decisions are based on the financial rate of return of an investment product. However, there are other criteria that may be also used to assist in the decision of where to make an investment, such as a company's adherence to environmental, social and governance (ESG) principles. ESG criterion are a set of standards for a company's operations that socially conscious investors use to screen potential investments.

Environmental criterion consider how a company performs as a steward of nature. As an example, environmental criterion may consider a company's energy usage, waste, pollution, natural resource conservation, and treatment of animals. Environmental criterion may also be used in evaluating a given environmental risk a company may face and how the company is managing the risk. As an illustrative example, a company may be facing issues related to its disposal of hazardous waste or its compliance with government environmental regulations.

Social criterion examine how a company manages relationships with employees, suppliers, customers, and the communities where it operates. Governance criterion deal with a company's leadership, executive pay, audits, internal controls, and shareholder rights.

Companies that incorporate these traits into their core philosophies are seemingly more aligned with stakeholder interests and often have better financial performance over the long run than those companies with weaker ESG records. As ESG-minded business practices gain more traction, investment firms are increasingly tracking their performance. In fact, increasingly younger investors are placing their money where their values lie.

Sustainable investing is on the rise and investors are currently adopting strategies that combine these ESG principles with existing methods of identifying attractive investment opportunities. However, this is still an evolving field and there is no conclusive process on how best to construct ESG portfolios that optimally combine profit maximizing characteristics with ESG characteristics, as well as client-specific requirements. Thus, what is needed is an enhanced system that aggregates ESG impact data and sustainable product data for sustainable investment portfolios.

### Examples of Related Art Include:

U.S. Ser. No. 10/346,920B2 describes systems and techniques for structuring and analyzing a fixed-income security. The fixed-income security includes a coupon that provides at least a variable rate of interest payment over a time interval. The variable rate of interest payment may be based at least in part on a set of ESG goals defined for an issuer over the time interval. A set of ESG values associated with performance of the issuer and corresponding to the set of ESG goals may be reported, independently audited, and used to determine the variable rate of interest payment provided by the security.

WO2019103183A1 describes an ESG criteria-based enterprise evaluation device and an operation method thereof. An ESG criteria-based enterprise evaluation device includes: a news collecting unit for evaluating an enterprise in terms of the ESG criteria to calculate scores, collecting a plurality of news articles on the Internet, classifying the same by date or enterprise, and clustering news articles with similarities that are equal to or higher than a reference value through an analysis of similarities between the news articles; a news classification unit for classifying each of the news articles according to whether the same is related to an environment, society or governance issue; and an evaluation result derivation unit for calculating an ESG risk for a corresponding cluster in a cluster unit and calculating an ESG enterprise evaluation score on the basis of the calculated value.

JP2018109936A describes a method to form a portfolio effectively utilizing ESG information and financial information. An ESG score value and a financial score value are calculated for each brand, and a brand subjected to investment is defined in accordance with a combination of the ESG score value with the financial score value. When the brand subjected to investment is defined, a total evaluation value of the brand subjected to investment is calculated, and an upper-rank brand is selected as a portfolio constructing brand. Moreover, an investment weight is decided on the basis of the ESG score value, and a portfolio is constructed.

CN103154991B describes systems and techniques for developing and implementing a credit risk model using various sources of data, including price data, financial accounting ratios, ESG data, and textual data. Each source of data provides unique and distinct information about the health of an entity, such as a firm or company. The systems and techniques combine information from disparate sources to create a uniquely powerful signal. The systems and techniques can be used to predict a number of events including, but not limited to, probability of default or bankruptcy, loss given default, probability of rating agency rating change, and probability of equity price moves.

U.S. Pat. No. 9,466,084B2 describes systems and techniques for structuring and analyzing a fixed-income security. The fixed-income security includes a coupon that provides at least a variable rate of interest payment over a time interval. The variable rate of interest payment may be based at least in part on a set of ESG goals defined for an issuer over the time interval. A set of ESG values associated with performance of the issuer and corresponding to the set of ESG goals may be reported, independently audited, and used to determine the variable rate of interest payment provided by the security.

U.S. Pat. No. 8,671,040B2 describes systems and techniques for developing and implementing a credit risk model using various sources of data, including price data, financial accounting ratios, ESG data, and textual data. Each source of data provides unique and distinct information about the health of an entity, such as a firm or company. The systems and techniques combine information from disparate sources to create a uniquely powerful signal. The systems and techniques can be used to predict a number of events including, but not limited to, probability of default or bankruptcy, loss given default, probability of rating agency rating change, and probability of equity price moves.

Some similar systems exist in the art. However, their means of operation are substantially different from the present disclosure, as the other inventions fail to solve all the problems taught by the present disclosure.

### SUMMARY OF THE EMBODIMENTS

The present invention and its embodiments relate to systems and methods for aggregating ESG impact data and sustainable product data for sustainable investment portfolios.

A first embodiment of the present invention describes a method executed by an engine of a computing device for aggregating environmental, social, and governance (ESG) impact data and sustainable product data for sustainable investment portfolios. The method includes several process steps, such as: collecting ESG impact data and sustainable product data from external data sources, aggregating the ESG impact data and the sustainable product data, transferring the aggregated data to a sustainable wealth management platform, and providing a user access to interact with the sustainable wealth management platform to track, measure, and understand an impact of an investment in a sustainable investment portfolio.

In some examples, the method further includes: determining an inability to locate the ESG impact data and the sustainable product data from the external data sources and prompting a human analyst to remedy any deficiencies. In some examples, the aggregation of the ESG impact data and the sustainable product data occurs via an artificial intelligence algorithm.

In other examples, the sustainable wealth management platform comprises a lookup tool such that the method further comprises: receiving, from the user via the lookup tool, at least a date of the user's first investment, a ticker symbol or ISIN of a holding within the sustainable investment portfolio, and a weight of the holding within the sustainable investment portfolio, creating an individualized report of a financial performance and a sustainable performance of the sustainable investment portfolio, and displaying the individualized report via a graphical user interface (GUI) of the computing device to the user.

In additional examples, the sustainable wealth management platform comprises a screening tool such that the method further comprises: receiving, from the user via the screening tool, an input. The input comprises at least one of: fund financial or sustainable criteria, company financial or sustainable criteria, and country financial or sustainable criteria. The method also includes identifying a list of funds, companies, or countries that match the input, displaying the identified list to the user via the GUI of the computing device, and allowing the user to export the identified list. The fund financial or sustainable criteria includes a fund type, an asset manager, and/or a controversy. The company financial or sustainable criteria includes: a region, a sector, and/or an industry. The country financial or sustainable criteria includes a region, a sustainable performance, and/or an exclusion.

In further examples, the sustainable wealth management platform comprises a matching tool such that the method further comprises: receiving, from the user via the matching tool, an input. The input includes investment goals of the user, an income of the user, an initial investment amount for the user, a monthly contribution amount for the user, and a risk tolerance associated with the user. The method further includes: prompting the user to select one or more sustainable development goals, determining funds that match the input and the one or more sustainable development goals of the user, automatically displaying a model sustainable investment portfolio comprising the funds via the GUI of the computing device, and allowing the user to export the model.

Additionally, in some examples, the sustainable wealth management platform comprises a portfolio sharing tool such that the method further comprises generating a shareable link that allows the user to view and share the sustainable investment portfolio.

A second embodiment of the present invention describes a computer system. The computer system is configured to aggregate environmental, social, and governance (ESG) impact data and sustainable product data for sustainable investment portfolios. The computer system includes: one or more external data sources, a computing device, a database or repository, and a sustainable wealth management platform.

The computing device includes a GUI and an engine. The engine includes at least one algorithm. The engine is configured to: collect ESG impact data and sustainable product data from the one or more external data sources, aggregate the ESG impact data and the sustainable product data, transfer the aggregated data to a sustainable wealth management platform, and provide access to a user to interact with one or more tools of the sustainable wealth management platform to track, measure, and understand an impact of an investment in a sustainable investment portfolio.

The database or repository is configured to store the aggregated data and the sustainable investment portfolio. The sustainable wealth management platform includes at least a lookup tool, a screening tool, and a matching tool. The lookup tool is configured to: receive, from the user, at least a date of the user's first investment, a ticker symbol or ISIN of a holding within the sustainable investment portfolio, and a weight of the holding within the sustainable investment portfolio, create an individualized report of a financial performance and a sustainable performance of the sustainable investment portfolio, and display the individualized report via the GUI.

The screening tool is configured to: receive, from the user, an input. The input comprises at least one of: fund financial or sustainable criteria, company financial or sustainable criteria, and country financial or sustainable criteria. Further, the screening tool is configured to: identify a list of funds, companies, or countries that match the input and display the identified list to the user via the GUI.

The matching tool is configured to: receive, from the user, an input. The input is selected from the group consisting of: investment goals of the user, an income of the user, an initial investment amount for the user, a monthly contribution amount for the user, and a risk tolerance associated with the user. The matching tool is further configured to: prompt the user to select one or more sustainable development goals, determine funds that match the input and the one or more sustainable development goals of the user, and automatically display a model sustainable investment portfolio comprising the funds via the GUI.

In some examples, the engine is further configured to: identify each company within the sustainable investment portfolio and match each company with one or more indicators on an exclusion and watch list. In response to a determination that a company is involved in an entirety of the one or more indicators on the exclusion and watch list, the engine is further configured to assign a first indicator to the company. In response to a determination that the company is not involved in the entirety of the one or more indicators on the exclusion and watch list, the engine is further configured to determine if the company is involved with at least one of the one or more indicators on the exclusion and watch list. In response to a determination that the company is involved with the at least one of the one or more indicators on the exclusion and watch list, the engine is further configured to assign a second indicator to the company. Additionally, in response to a determination that the company is not involved with the at least one of the one or more indicators on the exclusion and watch list, the engine is further configured to assign a third indicator to the company. Each of the first indicator, the second indicator, and the third indicator differ.

Moreover, each indicator of the one or more indicators on the exclusion and watch list are selected from the group consisting of: abortifacients, adult entertainment, adult entertainment revenue, alcohol, alcohol revenue, animal testing, animal welfare, civilian firearms, civilian firearms revenue, contraceptives, fossil fuels, gambling, gambling revenue, genetically modified organisms (GMOs), united nations (UN) international labor organization (ILO), military weapons, military weapons revenue, nuclear energy, nuclear energy revenue, pesticides, pork products, stem cell research, tobacco, tobacco revenue, UN global compact, climate, waste, toxic, water, human rights, child labor, employees, diversity, employees health & safety, privacy, marketing, anti-competitions practices, corruption and fraud, and product quality.

Additionally, in some examples, the engine is further configured to: retrieve, from the database or the repository, a sustainable score for each product that belongs to each company in the sustainable investment portfolio, calculate a product sustainability score for each company, and calculate an overall sustainability score for each company.

In other examples, the engine is further configured to: receive information from the user. The information includes: a first name of the user, a last name of the user, an email address associated with the user, a telephone number associated with the user, a date of a first investment by the user, a total monetary amount that the user wants to invest in U.S. dollars, funds that the user wishes to invest in by ISIN number or ticker, a weight of the funds within the investment portfolio, an indication if the user wants to keep any amount of the investment in cash, and/or securities and an associated percentage of the security. The engine is further configured to: determine if the ISIN number or the ticker is valid and if a sum of the funds and the cash equal 100%.

If the ISIN number or the ticker is invalid and the funds and the cash fail to equals 100%, the engine is further configured to: transmit the information for verification and correction and provides an error message to the user identifying the error and prohibits the creation of the sustainable investment portfolio. If the ISIN number or the ticker is valid and the funds and the cash equals 100%, the engine is further configured to: save the information in the sustainable investment portfolio, add the sustainable investment portfolio to the database or the repository, calculate a weight of each holding within the sustainable investment portfolio by multiplying a weight of a holding within a fund by a weight of the fund within the sustainable investment portfolio, and determine if the same holding belongs to at least two funds.

If the same holding belongs to the at least two funds, the following equation is utilized:

TotalHoldingWeightₓ=Σₙ₌₀^{n=y} HoldingWeight(n)*FundWeight(n),

wherein:
“x” is the Portfolio unique ID;
“y” is the amount of funds added to the portfolio;
“n” is the positional identifier for a given fund within the portfolio;
“TotalHoldingWeight” is the result of the sum of all the sub values;
“HoldingWeight” is the weight of the holding within a specific fund; and
“FundWeight” is the weight of a specific fund within the portfolio.

### BRIEF DESCRIPTION OF THE DRAWINGS

FIG. 1 depicts a schematic diagram of ESG principles, according to at least some embodiments disclosed herein.

FIG. 2 depicts a block diagram of a system, according to at least some embodiments disclosed herein.

FIG. 3 depicts a flowchart associated with determining if a given company is associated with one or more indicators on an exclusion and watch list, according to at least some embodiments disclosed herein.

FIG. 4 depicts a schematic diagram of one or more indicators on an exclusion and watch list for given companies in a portfolio, according to at least some embodiments disclosed herein.

FIG. 5 depicts a flowchart associated with calculating a sustainable weight of a company within a portfolio, according to at least some embodiments disclosed herein.

FIG. 6 depicts a schematic diagram of environmental criteria scores with a benchmark for given companies in a portfolio, according to at least some embodiments disclosed herein.

FIG. 7 depicts a schematic diagram of social criteria scores with a benchmark for given companies in a portfolio, according to at least some embodiments disclosed herein.

FIG. 8 depicts a schematic diagram of governance criteria scores with a benchmark for given companies in a portfolio, according to at least some embodiments disclosed herein.

FIG. 9 depicts a product sustainability flowchart, according to at least some embodiments disclosed herein.

FIG. 10 depicts a schematic diagram showing profiles associated with clients, according to at least some embodiments disclosed herein.

FIG. 11 depicts a schematic diagram showing an overall sustainability, as well as an environmental criteria score, a social criteria score, a governance criteria score, an impact score, and a products score for a given portfolio, according to at least some embodiments disclosed herein.

FIG. 12 depicts a schematic diagram showing various sustainable products for a given category, according to at least some embodiments disclosed herein.

FIG. 13 depicts a schematic diagram showing an illustrative sustainable product profile, according to at least some embodiments disclosed herein.

FIG. 14 depicts a flowchart for a portfolio creation process, according to at least some embodiments disclosed herein.

FIG. 15 depicts a schematic diagram showing information entered by the user/client for portfolio creation, according to at least some embodiments disclosed herein.

FIG. 16 depicts a schematic diagram showing an example portfolio, according to at least some embodiments disclosed herein.

FIG. 17 depicts a schematic diagram showing example holdings, according to at least some embodiments disclosed herein.

FIG. 18 depicts a schematic diagram setting the time frame for visualization for a rolling performance report, according to at least some embodiments disclosed herein.

FIG. 19 depicts another schematic diagram setting the time frame for visualization for a rolling performance report, according to at least some embodiments disclosed herein.

FIG. 20 depicts a flowchart associated with data flow for a rolling performance report, according to at least some embodiments disclosed herein.

FIG. 21 depicts a flowchart associated with a method to display or show an SDG report for a portfolio, according to at least some embodiments disclosed herein.

FIG. 22 depicts a schematic diagram showing an SDG report for a portfolio, according to at least some embodiments disclosed herein.

FIG. 23 depicts another schematic diagram showing an SDG report for a portfolio, according to at least some embodiments disclosed herein.

FIG. 24 depicts a block diagram of components of a computing device, according to at least some embodiments disclosed herein.

### DESCRIPTION OF THE PREFERRED EMBODIMENTS

The preferred embodiments of the present invention will now be described with reference to the drawings. Identical elements in the various figures are identified with the same reference numerals. Reference will now be made in detail to each embodiment of the present invention.

Such embodiments are provided by way of explanation of the present invention, which is not intended to be limited thereto. In fact, those of ordinary skill in the art may appreciate upon reading the present specification and viewing the present drawings that various modifications and variations can be made thereto.

### ESG Principles

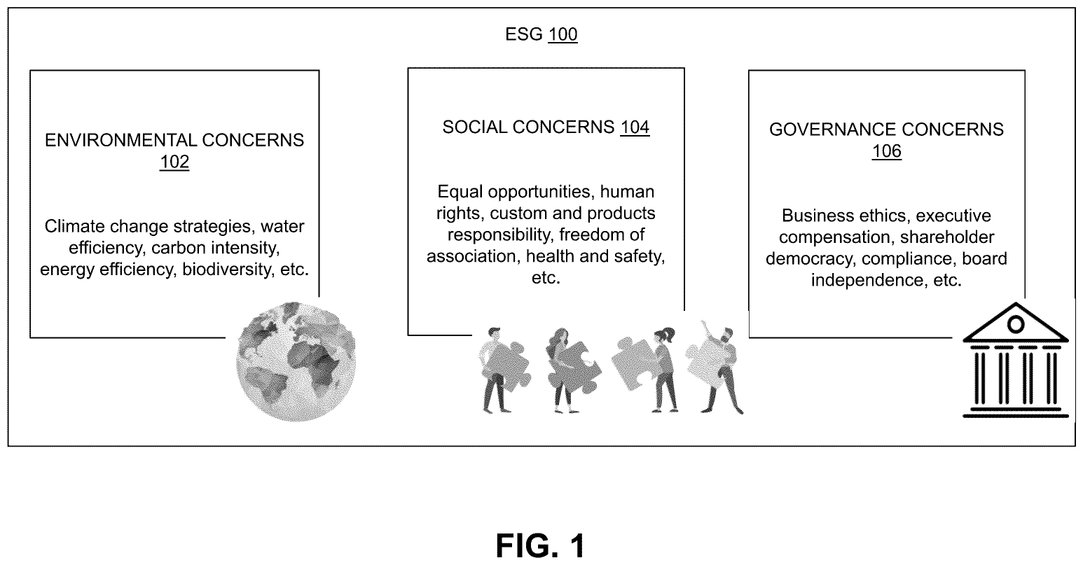

FIG. 1 depicts a schematic diagram of several ESG principles, according to at least some embodiments disclosed herein. As described herein, “ESG criteria” or “ESG concerns” are a set of standards for a company's operations that socially conscious investors use to screen potential investments. Put another way, ESG criteria is an evaluation of a firm's or company's collective conscientiousness for social and environmental factors. ESG investing focuses on investing in companies that are responsible with regards to: environmental concerns or criteria 102, social concerns or criteria 104, and corporate or governance concerns or criteria 106.

It should be appreciated that no single company may pass every test in every category. As such, investors need to decide what is most important to them. Further, the example environmental criteria 102, the social criteria 104, and the corporate or governance criteria 106 are being provided for illustrative purposes only and other concerns and criteria not explicitly listed herein are contemplated by the present disclosure.

### Environmental Concerns or Criteria 102

In general, the environmental criteria 102 considers how a company performs as a steward of nature. The environmental criteria 102 include a company's energy use, waste, pollution, natural resource conservation, and treatment of animals. The criteria can also be used in evaluating any environmental risks a company might face and how the company is managing those risks.

For example, there might be issues related to its ownership of contaminated land, its disposal of hazardous waste, its management of toxic emissions, or its compliance with government environmental regulations. Example environmental concerns 102 may include: climate change strategies; water efficiency protocols; carbon intensity protocols; energy efficiency protocols; and/or biodiversity, among others. When assessing the environmental concerns 102, one may ask: does the company engage in air, water, or other types of pollution?; does the company utilize renewable energy sources?; does the company comply with waste management programs?; has the company faced any deforestation issues, and if so, has the company handled the issues responsibly?; does the company use fair trade suppliers and organic ingredients?; and/or does the company follow biodiversity practices on its own land?, among others.

### Social Concerns or Criteria 104

The social criteria 104 examines how a company manages relationships with employees, suppliers, customers, and the communities where it operates. The social criteria 104 looks at the company's business relationships and may pose one or more of the following questions: does the company work with suppliers that hold the same values as it claims to hold?; does the company donate a percentage of its profits to the local community or encourage employees to perform volunteer work there?; does the company's working conditions show high regard for its employees' health and safety?; are other stakeholders' interests taken into account?, etc.

When assessing the social concerns 104, one may additionally ask: does the company provide equal opportunities?; does the company engage in fair pay when comparing a job to other jobs in the industry?; what types of retirement plans does the employer offer?; what benefits or perks are employees provided with?; does the company comply with human rights regulations?; does the company engage in custom and products responsibility?; does the company allow freedom of association?; are health and safety protocols followed?; does the company provide a diverse and inclusive workplace?; does your company provide financial support for continuing or higher education and/or flexible working hours for employees pursuing further education?; what opportunities exist for employees to be trained in new job skills at the company that will qualify them for higher-paying positions?; what level of employee engagement with management is there?; how much input do employees have in determining operational procedures within their respective departments?; what is the level of employee turnover?; what's the company's mission statement and is it socially relevant and beneficial to society?; how well are customer relationships managed?; does the company engage with customers on social media?; how responsive and efficient is the customer service department?; does the company have a negative history of consumer protection issues, such as product recalls?; does the company take a public or political stance on human rights issues?; and/or does it donate money to charitable causes?, among others.

### Corporate or Governance Concerns or Criteria 106

The corporate or governance criteria 106 deals with a company's leadership, executive pay, audits, internal controls, and shareholder rights. When assessing the corporate or governance criteria 106, investors may want to know that a given company uses accurate and transparent accounting methods and that stockholders are allowed to vote on important issues. Investors may also want assurances that a given company avoids conflicts of interest in their choice of board members, does not use political contributions to obtain unduly favorable treatment and, of course, does not engage in illegal practices.

When assessing the corporate or governance criteria 106, one may ask: how well do executive management and the board of directors attend to the interests of the company's various stakeholders—employees, suppliers, shareholders, and customers?; does the company give back to the community where it is located?; are the board members and company executives a diverse and inclusive group?; is extra compensation for executives appropriately tied to increasing the long-term value, viability, and profitability of the business?; does the company comply with business ethics principles?; do executive bonuses depend on more than just revenue or income (e.g., factors such as employee, shareholder, and customer satisfaction)?; and/or does the company provide shareholder democracy?; among others.

### System

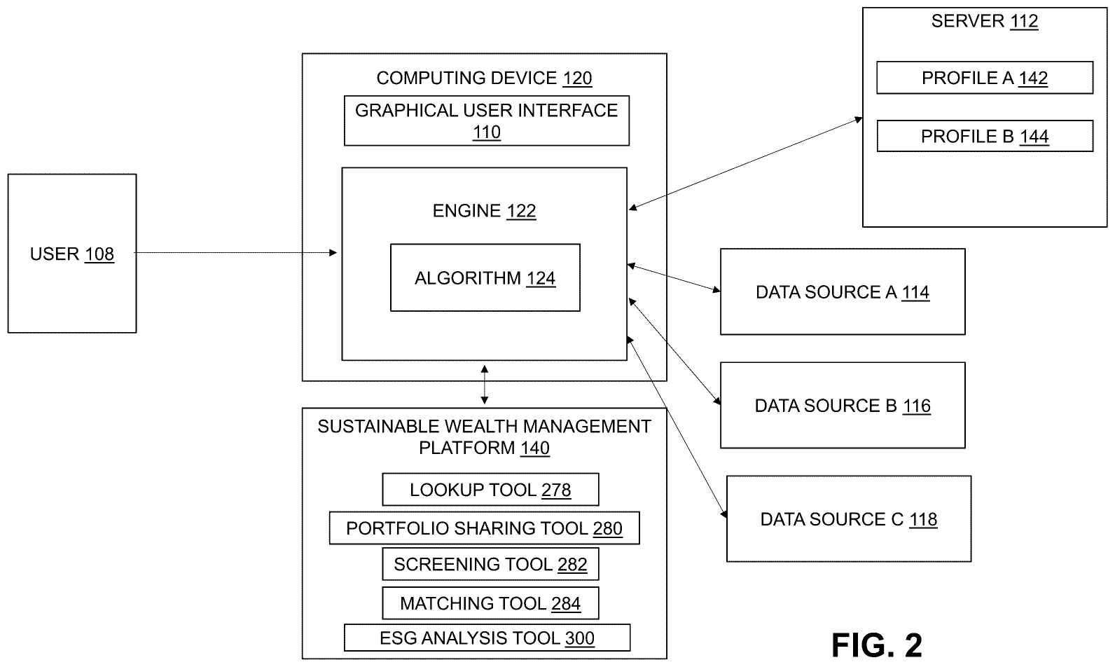

FIG. 2 depicts a block diagram of a system, according to at least some embodiments disclosed herein. The system described herein includes numerous components, such as a computing device 120. The computing device 120 may be a computer, a laptop computer, a smartphone, and/or a tablet, among other examples not explicitly listed herein. In general, the computing device 120 comprises an engine 122 and a graphical user interface (GUI) 110. In some examples, the engine 122 may be an application, a software program, a service, or a software platform configured to be executable on the computing device 120.

In some examples, the engine 122 may comprise one or more algorithms 124 (e.g., artificial intelligence algorithms and/or machine learning algorithms) that assist the engine 122 in performing process steps of the methods described herein. The engine 122 is configured to interact with a server 112 (or a database) and one or more external data sources, such as a data source A 114, a data source B 116, and/or a data source C 118, among others.

The system described herein also comprises a cloud Domain Name System (DNS) web service, an elastic load balancer (ELB) that automatically distributes incoming application/engine traffic across multiple targets and virtual appliances in one or more availability zones, and a virtual private cloud (VPC) that is an on-demand configurable pool of shared resources allocated within a public cloud environment that provides a level of isolation between different organizations using the resources.

Further, the system includes an API gateway tool that creates, publishes, maintains, monitors, and secures application programming interfaces (or APIs) at any scale. Additionally, the system includes a serverless computing service that allows for the running of code without provisioning or managing servers, creating workload-aware cluster scaling logic, maintaining event integrations, or managing runtimes. Moreover, the system includes a Cognito component (such as Amazon Cognito) that provides authentication, authorization, and user management for web and mobile applications.

Additionally, the system includes APIs that are a set of definitions and protocols for building and integrating application software. The system may further include a fully managed NoSQL database service that provides fast and predictable performance with seamless scalability, a relational database that stores and provides access to data points that are related to one another, and an asynchronous worker that gathers a status and outputs of steps periodically.

When a user 108 wishes to access a sustainable wealth management platform 140, the user 108 may input login credentials via the GUI 110 and into the engine 122. The login credentials may include a username, a password, a biometric identification means (e.g., fingerprint identification, face recognition identification, palm print identification, iris recognition, retina recognition, etc.), etc. In response, the engine 122 may identify the user 108 based on the login credentials. Identification of the user 108 may include information such as: a name of the user 108, a telephone number of the user 108, an address of the user 108, a profile associated with the user 108 (e.g., a profile A 142 or a profile B 144).

In some examples, identifying the user 108 based on the login credentials may include: querying the server 112 to compare the login credentials of the user 108 with information or data stored in the profiles (e.g., the profile A 142, the profile B 144, etc.) and determining if the user 108 has already registered and has an active account or profile. If it is determined that the user 108 is associated with the profile (e.g., the profile A 142), the user 108 may be granted access to the sustainable wealth management platform 140.

If it is determined that the user 108 does not have an account or profile stored on the server 112, the engine 122 may prompt the user 108 to create such profile. Responsive to the creation of such profile, the engine 122 may grant the user 108 access to the sustainable wealth management platform 140.

In general, the engine 122 may engage in a method that includes the following process steps: (1) collecting data (e.g., ESG impact data and sustainable product data), (2) aggregating the data, and (3) transferring the data to the sustainable wealth management platform 140. As described herein, the sustainable wealth management platform 140 assists the user 108 in demystifying sustainable investing and allows the user 108 to track the ESG impact of a wide variety of portfolios. The sustainable wealth management platform 140 also allows the user 108 to understand, track, and measure the impact of investments. In general, the user 108 may engage the GUI 110 of the computing device 120 to access the sustainable wealth management platform 140. The sustainable wealth management platform 140 may include numerous tools, such as: a lookup tool 278, a portfolio sharing tool 280, a screening tool 282, a matching tool 284, and an ESG analysis tool 300, which will be described herein.

### Data Collection Process

The data collection process will be generally described herein. Specifically, the engine 122 may collect data from one or more external data sources (e.g., the data source A 114, the data source B 116, and/or the data source C 118, among others) including various company reports and publications. Sustainability reports and other sources are collected in a repository where data can then be pulled using filters and keywords from the algorithm 124. If the algorithm 124 is unable to find the appropriate data, then in-house human analysts correct any mistakes.

The data may include: (1) data for impact indicators (e.g., ESG impact data) and revenue distribution portion of the sustainable wealth management platform 140 and (2) data for sustainable products and controversies data. The (1) data for impact indicators and revenue distribution portion of the sustainable wealth management platform 140 is mainly quantitative, whereas the (2) data for the sustainable products and controversies data is mainly qualitative.

The engine 122 may collect the data for impact indicators (e.g., ESG impact data) from multiple third-party databases/external data sources (such as the data source A 114 and/or the data source B 116).

In some examples, the ESG impact data values represent data aggregated for the past fifteen years for each company (and the cumulative total). The impact indicator score itself is based on the amount of data disclosed by each company. If more companies publish the data captured by a sub-impact indicator, then that sub-impact indicator receives a higher score, taking into account the weight that every single company has in its portfolio. The final score of the ESG impact indicator is the average of all the single sub-impact indicators' scores, equally weighted.

Regarding the data for the sustainable products, each sustainable product has a description that explains its sustainability aspects to the client or user 108. For example, a product made with 100% recycled aluminum and other recycled material in an industry where it would be uncommon to use recycled materials would be labeled as sustainable. The engine 122 also receives data from external data sources, and more. This data is then aggregated with the data found through the AI machine learning process and provides information not covered by other external data sources.

The final score of the ESG impact indicator takes into account a “total impact,” meaning it takes into account only positive indicators. Positive sub-indicator scores are summed before dividing the sum by the number of the sub-indicators that a particular indicator has. This way the positive impact is assessed, while excluding the negative impact. The formula for calculating a final impact indicator score is demonstrated below in Equation 1.

(Subindicator Score 1+Subindicator Score 2+Subindicator Score 3)/3=Total Impact Indicator Score [Equation 1]

An example is demonstrated below in Table 1A and Table B using an “Emissions Score” on the sustainable wealth management platform 140. Table 1B is a continuation of Table 1A.

TABLE 1A

| | Portfolio | SCOPE 3_data | TotalVOC_data |
|---|---|---|---|
| Portfolio Holdings | weight | disclosed | disclosed |
| Nike | 40% | 1 | 1 |
| Adidas | 20% | 1 | 1 |
| Bank of America | 10% | 0 | 0 |
| Apple | 10% | 1 | 1 |
| Microsoft | 8% | 1 | 0 |
| Alibaba | 5% | 1 | 0 |
| Amazon | 2% | 1 | 1 |
| Facebook | 2% | 0 | 0 |
| Tesla | 2% | 0 | 1 |
| Nvidia | 1% | 0 | 1 |
| Sub-Indicator SCORE | | 85 | 75 |
| Emissions SCORE | 76 | | |

TABLE 1B

| | SCOPE | SCOPE | GHG | | |
|---|---|---|---|---|---|
| Portfolio | 2_data | 1_data | Emissions_data | | |
| Holdings | disclosed | disclosed | disclosed | TotalNOx | TotalSOx |
| Nike | 1 | 1 | 1 | 1 | 1 |
| Adidas | 1 | 1 | 0 | 0 | 1 |
| Bank of America | 0 | 1 | 1 | 1 | 0 |
| Apple | 1 | 1 | 1 | 1 | 1 |
| Microsoft | 0 | 0 | 0 | 0 | 0 |
| Alibaba | 1 | 0 | 1 | 0 | 1 |
| Amazon | 1 | 1 | 1 | 1 | 1 |
| Facebook | 0 | 0 | 0 | 0 | 0 |
| Tesla | 1 | 1 | 1 | 0 | 0 |
| Nvidia | 0 | 1 | 1 | 1 | 1 |
| Sub-Indicator | 79 | 85 | 70 | 63 | 78 |
| SCORE | | | | | |

The “Emissions Score” in Table 1A and Table 1B is an average of all of the sub-indicator scores.

The 1's in Table 1A and Table 1B represent data disclosed by companies, while 0's in Table 1A and Table 1B represent data not disclosed. The sub-indicator scores themselves are calculated using Equation 2 below.

Total sum of data disclosed×Portfolio weight×100 Subindicator score [Equation 2]

In the case of an indicator only having one sub-indicator, the sub-indicator score is used as an overall indicator score, as demonstrated below in Table 2 with a “Community Engagement Score.”

TABLE 2

| | | Total donations by |
|---|---|---|
| | Portfolio | the company ($ |
| Portfolio Holdings | weight | millions) |
| Nike | 40% | 1 |
| Adidas | 20% | 1 |
| Bank of America | 10% | 0 |
| Apple | 10% | 1 |
| Microsoft | 8% | 0 |
| Alibaba | 5% | 1 |
| Amazon | 2% | 1 |
| Facebook | 2% | 0 |
| Tesla | 2% | 0 |
| Nvidia | 1% | 1 |
| Sub-Indicator SCORE | 78 | 78 |
| Community Engagement | | |
| SCORE | | |

Under the total portfolio, some indicators display a cumulative sum of the numbers used to portray that indicator, while others represent an average of those numbers. An example of portfolio cumulative data could be any kind of emissions, while data that requires the portfolio average could include a percentage of women on a company board. To calculate the cumulative score, the data collected from the databases is divided by the revenue of the company. This calculation is used such that one can fairly value a true impact of each company based on a size of the company's revenue stream. Since data is only being used from the last fifteen years, one may calculate an average of the data from the last fifteen years and assume that this applies to previous years. Afterward, the value for every year that each company has under the portfolio is summed for that year and multiplied by a weight of each company. After the sum for each year is calculated, a total cumulative value is calculated as a total of each year. An example is provided below demonstrating the process in Table 3A and Table 3B, where Table 3B is a continuation of Table 3A.

TABLE 3A

| Company | | | | |
|---|---|---|---|---|
| Name | Weight | Year 1 | Year 2 | Year 3 |
| Company A | 60% | 3.84 (average of | (200/100)*.6 = 1.2 | (500/100)*.6 = 3 |
| | | Year 2-6) | | |
| Company B | 40% | 1.84 (average of | | |
| | | Year 2-6) | (400/200)*4 = .8 | (600/200)*.4 = 1.2 |
| Sum | | 5.68 | 2 | 4.2 |

TABLE 3B

| Company | | | | |
|---|---|---|---|---|
| Name | Year 4 | Year 5 | Year 6 | Rev |
| Company A | (700/100)*.6 = 4.2 | (800/100)*.6 = 4.8 | (1000/100)*.6 = 6 | 100 |
| Company B | (1000/200)*.4 = 2 | (1400/200)*.4 = 2.8 | (1200/200)*.4 = 2.4 | 200 |
| Sum | 6.2 | 7.6 | 8.4 | |
| Total Sum | 34.08 | | | |

The same methodology may be used when calculating average portfolio totals, except the total average is found instead of the total sum.

### Data Aggregation Process

The data aggregation process will be generally described herein. The in-house human analysts review the data collected through the engine 122 and various external data sources before implementation onto the sustainable wealth management platform 140. The data collected from the AI algorithm 124 of the engine 122 provides any missing information that cannot be collected from external providers. In some examples, indicators from external sources that are similar may be aggregated in order to create a single, new indicator by the in-house human analyst. The analysts also create weights based on the sub-industry average for indicator scores that did not respond with the weight given. For example, a company in the real estate industry might be weighted differently than a company in the gas utility industry since the average score for those industries would be vastly different. The differentiation of the weights is based on an analysis led by an in-house human analyst determined by the materiality of each key performance indicator (KPI) on the basis of the sub-industry in which the company operates.

Each KPI is classified as “Highly Material”, “Material”, “Slightly Material”, or “Not Material” and is assigned a relative weight based on this classification. For example, the indicator “Climate Change” follows KPIs like “GHG emission intensity” and “Product Footprint”, where those two KPIs have different materiality if one is analyzing an Oil and Gas company or a software company. Based on that materiality, the in-house analyst assigns a weight to calculate a final overall sustainability score as a weighted average of KPI scores and relative weights.

Another element that the instant invention takes into consideration when assigning an overall sustainability score is a severity of a controversy related to a specific indicator, such that the more severe the controversy, the greater the deduction on the score. Overall sustainability scores are provided for each user's or individuals' portfolios, ESG Analysis, Impact Indicators, and Sustainable Products. The final score for the ESG Analysis is calculated by a weighted average of the indicators. The final score for impact indicators is calculated taking into account the impact of each sub-indicator. Further, the final score for sustainable products is calculated based on the weighted average of each sub-indicator used to evaluate the products.

### Sustainable Wealth Management Platform Functionalities

Furthermore, once the data is transferred from the engine 122 to the sustainable wealth management platform 140, the data may be used by different tools of the sustainable wealth management platform 140. As shown in FIG. 1, example tools include: a lookup tool 278, a portfolio sharing tool 280, a screening tool 282, a matching tool 284, and an ESG analysis tool 300.

First, the lookup tool 278 allows for two lookup options, the “Fund Lookup” that covers over 365,000 different publicly traded funds and the “Company Lookup” that covers over 10,000 publicly traded companies. By entering the day of the user's 108 first investment, the ticker symbols or ISINs of the holdings within the portfolio, the weighting of the portfolio, and the benchmark (if applicable), the system will automatically run through millions of data points to display a digestible portfolio analysis. Within seconds, the user 108 will see the option to enter either a “Portfolio” or “Performance 360” tabs, which provide an individualized breakdown of the portfolio's financial and sustainable performance.

Specifically, under the “Portfolio” tab, the user 108 can view the name of the companies or funds in the portfolio and their weighting. The user 108 is also provided the option to view the holdings within the portfolio, the asset class, the country, the currency, the sector, and the UN SDG alignment of the portfolio.

Under the “Performance 360” tab, the user 108 can view financial performance and sustainable performance. Within the financial performance tab, the user 108 can view a performance chart of the portfolio and the benchmark for any given time period, as well as risk and volatility metrics sourced from an external third-party. Within the sustainable performance tab, the portfolio and benchmark scores are displayed for 6 different metrics: environmental, social, governance, impact, and products. Portfolio scores are calculated by adding the product of every holding weight by the weight of the fund within the portfolio, while benchmark scores are calculated by the weighted average of the aggregated scores of each section of the sustainable wealth management platform 140.

Below the aforementioned scores are 4 tabs that hold the underlying data behind those scores, the tabs are titled: ESG analysis, impact indicators, sustainable products, and exclusion and watch list. The ESG analysis tool 300 provides a score for each holding in the portfolio for the 3 ESG pillars and their sub-indicators (ex: CO₂ emissions, health, and safety or corporate behavior). The impact indicators tab provides live data for a range of different ESG sub-indicators since the day of the first investment (ex: the amount of waste recycled, percentage of women employed, or renewable energy used). The sustainable products tab displays up to 5 different products for each company which can be titled sustainable for either their intended use, manufacturing, material sourcing etc. Lastly, the exclusion and watch list tab shows a list of different controversial activities sourced from the redistribution partners, and which companies have generated revenue in that particular activity. Products or services with excluded activities are cut from the companies offerings to limit controversial activities and are individually determined on a company-to-company basis. All information generated under the sustainable section of the performance 360 tab can be easily exported into a CSV file, besides the impact indicators for data protection.

The screening tool 282 is designed to make portfolio construction easy. The user 108 can screen down an investment universe based on a set of financial or sustainable criteria for the fund, company, or country they aim to invest in. Fund criteria include, but are not limited to: fund type, asset manager, and controversy; company criteria include, but are not limited to: region, sector, and industry; country criteria include: region, sustainable performance, and exclusion. As a result, the sustainable wealth management platform 140 will return a list of funds, companies, or countries that match the list inputted criteria. This list can be easily exported as a CSV file with the click of a button.

Next, the matching tool 284 serves as a robo-advisor, but this tool goes well beyond traditional risk and returns metrics. The matching tool 284 takes into account the user's 108 investment goals, income, initial investment, monthly contributions, and risk tolerance. Moreover, the matching tool 284 also accounts for the user's 108 sustainable priorities through UN SDG alignment, as the user 108 can select any or all of the 17 sustainable development goals to match the user's 108 investments with not only the user's 108 financial goals, but also the user's 108 sustainability goals. Once the user 108 has run the search, the system will automatically display a model portfolio to match the user's 108 needs. Once again, this list is exportable as a CSV file with just one click.

Further, the portfolio sharing tool 280 puts an end to static information sharing by providing a dynamic link to view the financial and sustainable data of the user's 108 portfolio. The user 108 may save any portfolio for any client. Once the user 108 has created the portfolio, the user 108 can press the “Click Link to Share” button to create a sharable link that when entered will display all the financial and sustainable information a client can ask for. Within the link, the user 108 is able to view the portfolio and performance 360 tabs mentioned. The link is fully interactive and dynamic for the user 108, allowing them to toggle between the limited range of tools offered in each section of the sustainable wealth management platform 140.

### ESG Scores

ESG scores assist in rating a sustainability performance of companies and their exposure to ESG-related risks. The ESG scores help socially conscious investors to compare the sustainability of the companies they're investing in with one another and become more aware of the effect their portfolio has on the ESG factors for that company.

As described herein, raw data is retrieved by the engine 122 from sustainability databases. The environmental criteria/indicator include the following: biodiversity land use, carbon emissions, climate change risk, electronic waste, energy efficiency, environmental impact with finance, environmental technology opportunities, green building opportunities, renewable energy opportunities, environmental product impact, carbon footprint of product, toxic emissions waste, and water shortage. The social criteria/indicator include the following: community engagement, finance for underserved communities, healthcare for underserved communities, chemical safety, financial product safety, problematic sourcing, health and safety, labor development, health risk, labor management, product safety and quality, cybersecurity, responsible investing, and supply chain. The governance criteria/indicator include the following: corporate ethics, corporate behavior, tax transparency, accounting, board, corporate governance, ownership and control, pay, anticompetitive practices, and corruption instability. It should be appreciated that though these indicators are described herein, these lists are non-exhaustive and other indicators may be used.

Considering the ESG scores, the in-house analysts may also create weights based on the sub-industry average for every single ESG indicator for indicator scores that didn't correspond with the weight given. Each indicator is given an social development goal or SDG allocation, as well. Additional information regarding the SDGs is described infra.

The final individual ESG scores are calculated by the weighted average of the indicators. Each indicator (multiplied by their weight) in a particular category (e.g., environmental criteria/concerns, social criteria/concerns, or governance criteria/concerns) is aggregated and divided by a sum of their weights (excluding the ones that were not given scores). The weights for each individual pillar (e.g., the social pillar) score are given by the in-house analysts based on the impact that pillar has on the industry a company is in, and all add up to 100%. For example, a company in the packaged foods and meats industry would have a weight of 30% for its social and governance score, while its environmental score weight would be 40%. The final overall ESG score is calculated by finding a weighted average of all of the ESG pillar scores combined.

ESG scores are important in order to properly compare the sustainability performance of companies with one another, which is why the instant invention provides numerical ESG scores in an ESG analysis section of the sustainable wealth management platform 140.

### Exclusion and Watch List Methodology

A popular strategy used by socially conscious investors is screening for/excluding companies that have controversial or otherwise harmful ESG-related practices. In order to do this, companies have to be continuously checked for possible controversial risks. Thus, an exclusion and watch list is a useful tool used by the instant invention for assessing which companies are preferable for socially responsible investments.

As described herein, an “exclusion and watch list” is a list of indicator categories representing controversial fields or activities in which a company might or might not be involved with. The exclusion and watch list includes ten different metrics it assesses for, seven of which are categories of products that socially conscious investors are likely to be concerned with and three of which assess for overall environmental, social, or governance controversies. These metrics include: alcohol, gambling, tobacco, adult entertainment, military weapons, fossil fuels, nuclear energy, environmental controversies, social controversies, and governance controversies. The categories associated with the exclusion and watch list are depicted in Table 4. It should be appreciated that the list provided in Table 4 is non-exhaustive.

TABLE 4

Abortifacients
Adult Entertainment
Adult Entertainment Revenue
Alcohol
Alcohol Revenue
Animal Testing
Animal Welfare
Civilian Firearms
Civilian Firearms Revenue
Contraceptives
Fossil Fuels
Gambling
Gambling Revenue
Genetically modified organisms (GMOs)
United Nations (UN) International Labor
Organization (ILO)
Military Weapons
Military Weapons Revenue
Nuclear Energy
Nuclear Energy Revenue
Pesticides
Pork Products
Stem Cell Research
Tobacco
Tobacco Revenue
UN Global Compact
Climate
Waste
Toxic
Water
Human Rights
Child Labor
Employees Diversity
Employees Health & Safety
Privacy
Marketing
Anti-Competitions Practices
Corruption & Fraud
Product Quality

It should be appreciated that the company's main activity does not have to be directly associated with one of these indicators in Table 4, but it may be the case where the company has received some kind of revenue from an activity associated with one of them (e.g., through investments or third party associations).

Further, the present invention analyzes a company's controversy by categorizing them under Four Pillars: (1) controversial activities, (2) environmental controversies, (3) social controversies, and (4) governance controversies. Each of these pillars consists of a set of KPIs that assess for controversial activity. After a controversy has been classified, a company is assigned a flag or is marked based on the parameters. In some examples, the flag or mark may be distinguished using a color (e.g., green, yellow, or red), a graphic (e.g., a flag), text, etc.

As explained herein, “controversial activities” include any company tie to a controversial activity plus a percentage of the company owned by a company involved in the controversial activity. The controversial activities pillar aggregates a percentage of revenue generated and a percentage of ownership to determine the flag or marker for the company. Additionally, the environmental/social/governance controversies pillars determine the flag or marker of the company by aggregating a severity and a quantity of the controversies that the company has undergone.

As an example, a green flag indicates companies that are not involved in any controversial activity or environmental/social/governance controversy. The yellow flag indicates companies with slight involvement in any controversial activity or environmental/social/governance controversies. Further, the red flag indicates companies with severe involvement in any controversial activity or environmental/social/governance controversy.

As such, a company with no tie to a controversial activity or not owned by a company involved in a controversial activity receives a green flag. A company with at least one indicator tied to a controversial activity or 20 to 49.99% owned by a company involved in a controversial activity receives a yellow flag. Further, a company with any tie to a controversial activity+>50% ownership by a company involved a controversial activity receives a red flag.

Further, a company not involved in any environmental/social/governance controversies or involved in one that is “minor” receives a green flag. A company involved in at least one environmental/social/governance controversy is deemed “moderate” and receives a yellow flag. Additionally, a company involved in at least one environmental/social/governance controversy that is deemed “severe” or “very severe” receives a red flag.

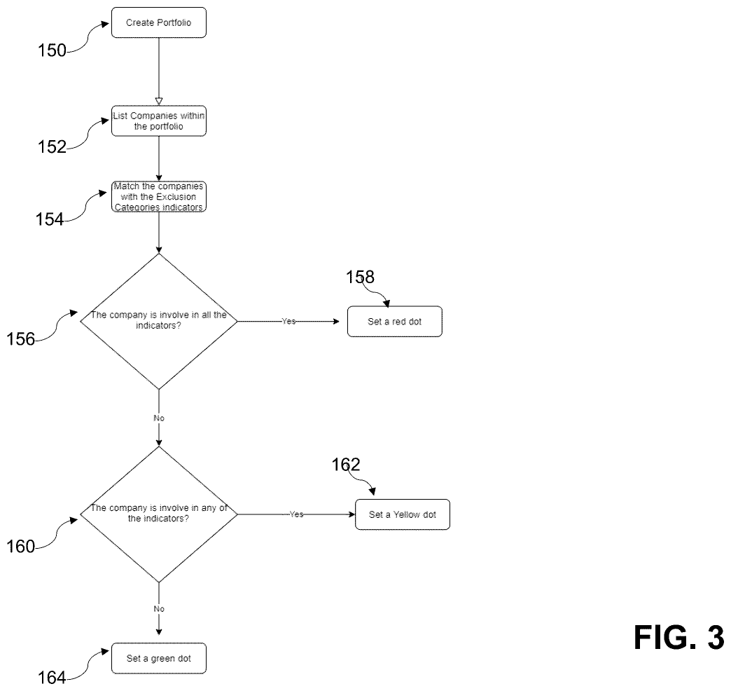

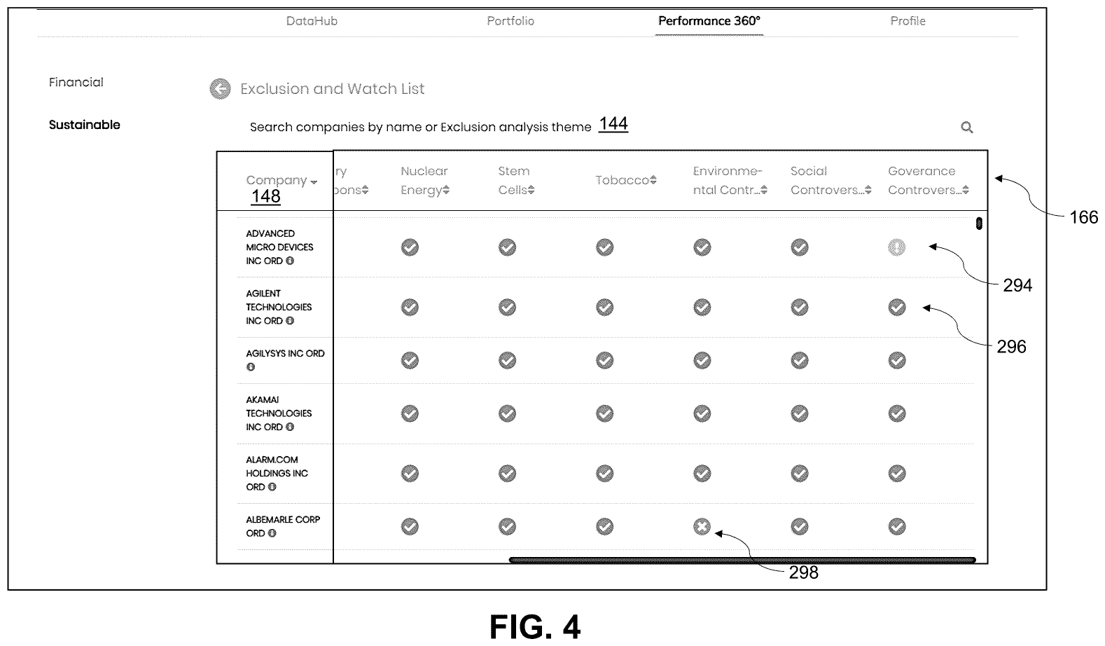

FIG. 3 depicts a flowchart associated with determining if a given company is associated with one or more indicators on the exclusion and watch list and FIG. 4 depicts a schematic diagram of one or more indicators 166 (e.g., nuclear energy, stem cells, tobacco, etc.) on the exclusion and watch list for given companies 148 in a portfolio.

The flowchart of FIG. 3 begins with a process step 150 where a portfolio is created. A process step 152 follows the process step 150 and includes listing the companies within the portfolio. A process step 154 follows the process step 152 and includes matching the companies with one or more indicators on the exclusion and watch list. A process step 156 follows the process step 154 and queriers if a given company is involved in all of the indicators on the exclusion and watch list.

If a “YES” response follows the process step 156, a process step 158 occurs where a first indicator 298 (of FIG. 4) is placed (e.g., a red dot). If a “NO” response follows the process step 156, a process step 160 occurs, where it is determined if the given company is involved in any of the indicators on the exclusion and watch list. If a “YES” response follows the process step 160, a process step 162 occurs where a second indicator 294 (of FIG. 4) is placed (e.g., a yellow dot). If a “NO” response follows the process step 160, a process step 164 occurs, where a third indicator 296 (of FIG. 4) is placed (e.g., a green dot). It should be appreciated that though colors are being used to distinguish the first indicator 298, the second indicator 294, and the third indicator 296, other graphical and/or textual indicators may be used. As shown in FIG. 4, the user 108 may engage the GUI 110 to search 144 for the companies 148 by name or exclusion analysis theme.

### ESG Calculation Process

The ESG calculation method is a three-step process. First, the engine 122 matches all of the companies within the portfolio that have sustainable scores and determines what percentage they represent within the total portfolio. Equation 3 may be used, as shown below.

$$P S W = \frac{( {\sum }_{i = 0}^{i = n} SustainableCompanies ( i ) )}{TotalPortfolioSize} \qquad [ Equation 3 ]$$

### Where:

“PSW” refers to a “Portfolio Sustainable Weight” that represents the percentage of sustainable companies within the portfolio;

“SustainableCompanies” refers to a list of all of the companies within the portfolio that have the sustainable score;

“i” is a variable index that represents a position on the list of Sustainable Companies;

“n” refers to a total of sustainable companies within the portfolio; and

“TotalPortfolioSize” refers to a total amount of companies within the portfolio.

Second, the engine 122 calculates an average of the sustainable weight by dividing the sum of the products of each company sustainable score by the company weight within the portfolio between the number of sustainable companies, as shown below in Equation 4.

$$A S W = \frac{\begin{matrix}{\sum }_{i = 0}^{i = n} SustainableCompany ( i ) . Weight * \\ SustainableCompany ( i ) . Score\end{matrix}}{TotalSustainableCompanies} \qquad [ Equation 4 ]$$

### Where:

“ASW” refers to the Average Sustainable Weight;

“SustainableCompanies(i).weight” refers to the weight of the company for that specific index within the portfolio;

“SustainableCompanies(i).Score” refers to the sustainable score of the company for that specific index within the portfolio;

“i” refers to the variable index to represent a position on the list of Sustainable Companies;

“n” refers to the total of sustainable companies within the portfolio; and

“TotalSustainableCompanies” refers to the total amount of sustainable companies within the portfolio.

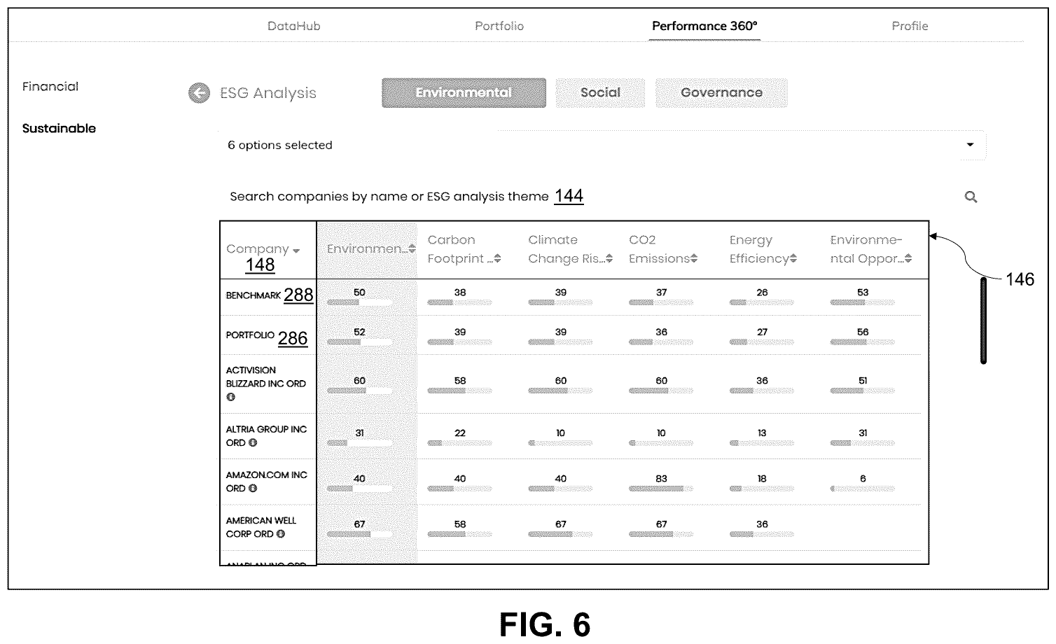

Third, engine 122 calculates the sustainable weight of the company by multiplying the ASW by the PSW. This process will be repeated for every ESG indicator and the sub-categories. If there is a benchmark involved (e.g., as shown in FIG. 6-FIG. 8), the process will be the same for the benchmark companies, and shown as an extra column on the system.

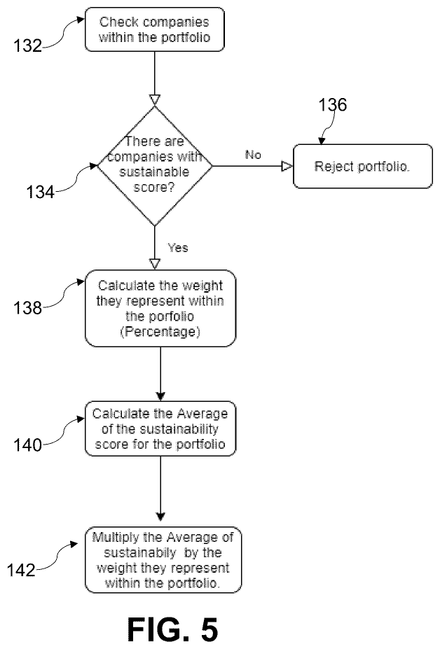

A flowchart associated with this process is shown in FIG. 5. FIG. 5 begins at a first process step 132 that includes checking companies within the portfolio. A process step 134 follows the process step 132 and includes determining if there are any companies with sustainable scores. If a “YES” response follows the process step 134, the method moves onto a process step 138. If a “NO” response follows the process step 134, a process step 136 occurs.

The process step 136 includes rejecting the portfolio. The process step 138 involves calculating the weight they represent within the portfolio as a percentage. A process step 140 follows the process step 138 and includes calculating the average of the sustainability score for the portfolio. A process step 142 follows the process step 140 and includes multiplying the average of the sustainability score for the portfolio by the weight they represent within the portfolio. The process step 142 concludes the method of FIG. 5.

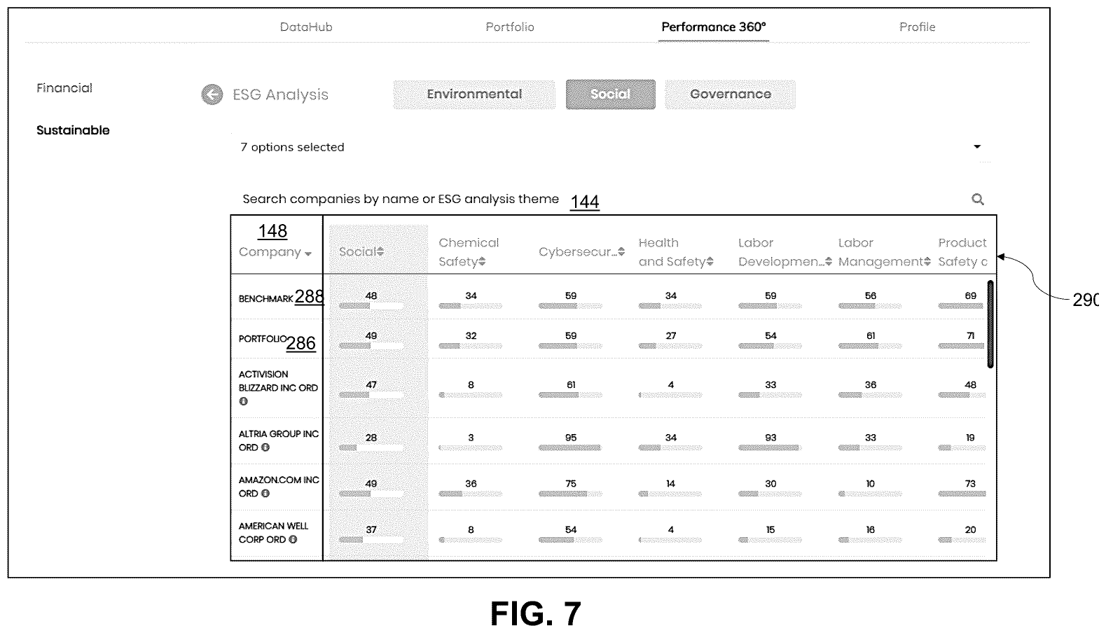

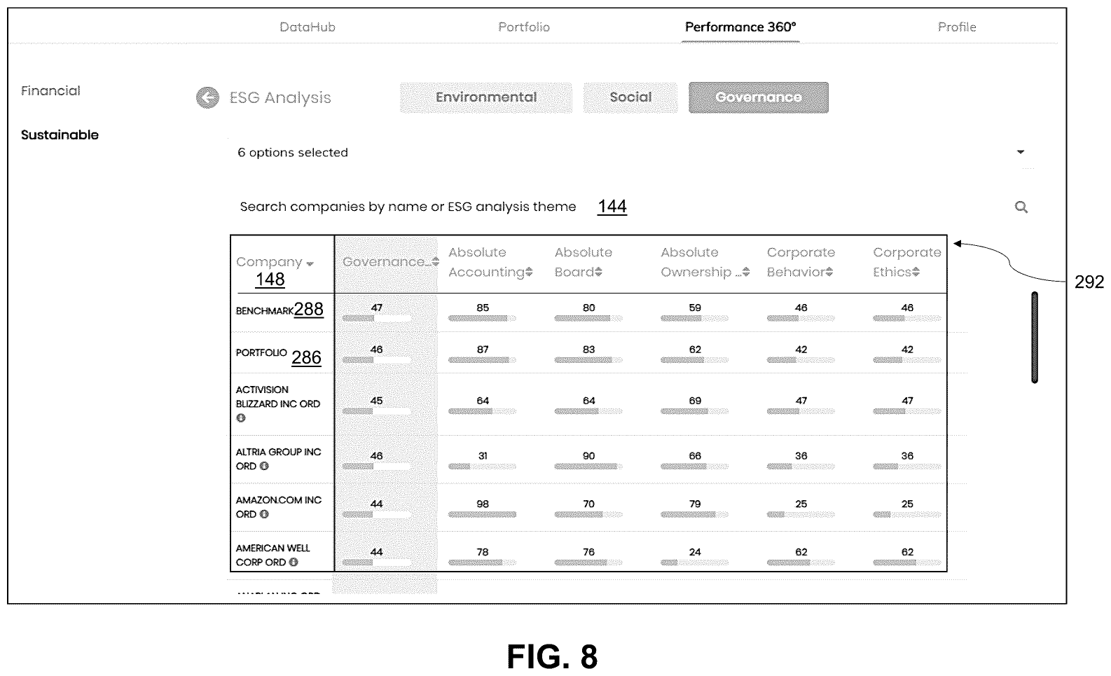

As explained herein, the user may view the results of the ESG analysis via the GUI 110. FIG. 6-FIG. 8 provide examples of such results. For example, as shown in FIG. 6-FIG. 8, the user may search 144 for companies 148 by name or ESG analysis theme (e.g., emissions management and resource use). FIG. 6 depicts a schematic diagram of environmental criteria 146 scores (including an overall environmental score and scores for each environmental criteria 146, such as carbon footprint, CO₂ response, energy efficiency, etc.) with a benchmark 288 for given companies 148 in a portfolio 286. FIG. 7 depicts a schematic diagram of social criteria 290 scores (including an overall social score and scores for each social criteria 290, such as chemical safety, cybersecurity, labor development, etc.) with the benchmark 288 for given companies 148 in the portfolio 286. FIG. 8 depicts a schematic diagram of governance criteria 292 scores (including an overall governance score and scores for each governance criteria 292, such as accounting, ownership, corporate behavior, etc.) with the benchmark 288 for given companies 148 in the portfolio 286. It should be appreciated that the ESG analysis of FIG. 6-FIG. 8 may be provided or presented without the benchmark 288 in examples.

### Sustainable Products

Despite the rise in popularity of ESG investment strategies, not much research has been conducted on the sustainability of specific products produced by companies. This information is vital to understanding the true sustainability of a company, as well as what the company produces and the impact that their products can have on the environment and the communities around them. Since there's a lack of transparency surrounding the reporting of products, however, finding reliable data on this pressing issue has proven difficult.

Sustainable product research aims to compare the sustainability of products between companies and to consolidate the current data we have access to about the environmental/social effects of products. The present invention focuses research on products that were specifically meant to be beneficially impactful to the environment and/or local communities, and how those products correlated to a company's overall operations. The present invention utilizes the United Nations SDGs as a framework through which to evaluate a product's impact attributes. It should also be noted that impact attributes are separate from the nature of a product. For example, despite meeting a critical societal need, food products are not considered impact products unless they contribute to sustainability in an additional way, like being sourced sustainably or being donated to underserved communities.

The present invention analyzed products through three different pillars: (1) scale of company impact, (2) product sustainability and relevance, and (3) product transparency. Each pillar has questions that receive their own individual score out of 100 and receives a final score in accordance with the weight given to it. As described herein, the “scale of company impact” pillar refers to how significant a contribution by a product is relative to how often it's produced. As described herein, the “product sustainability and relevance” pillar aims to answer the question of how sustainable a product is and how their impact product fits into the rest of their product offerings. Finally, as described herein, the “product transparency” pillar simply assesses how transparent companies are about their products based on how much information was given about a certain product. Each pillar is given a weight relative to how important its assessment is for the sustainability of a product.

Each product also received one to two SDG alignments and a percentage based on how much a specified SDG aligned with the product. In-house analysts first provide a raw percentage to each impact product and the final percentage was determined using a premium multiplier. The purpose of the premium multiplier is to create lower values for SDGs that appear more frequently than others and to reward products that cover more unique SDGs that others don't cover.

### Product Sustainability Per Company Calculation

The product sustainability per company, as well as the overall product sustainability may be calculated. For the product sustainability per company calculation, the engine 122 first retrieves from an in-house database the sustainable score for each product that belongs to each company. Then, each company's sustainability is calculated. A company's sustainability is the average (AVG) of each product score. For example, if company A has three products X, Y and Z, where X has a score of 50, Y has 60, and Z has 40, the sustainability of A would be 50. This calculation is formalized in Equation 5 below.

$$sustainabilityA = \frac{s c o r e X + s c oreY + scoreZ}{p r o d u c t s Q u a n t i t y} \qquad [ Equation 5 ]$$

The equation can then be formalized as Equation 6 below.

$$Company product sustainability = \frac{{\sum }_{i = 0}^{i = n} {score}_{i}}{n} \qquad [ Equation 6 ]$$

### Where:

“i” refers to the index variable that loops through the total amount of scores; and “n” refers to the total number of product scores within a company.

### Overall Product Sustainability Calculation

For the overall product sustainability, the engine 122 first retrieves, from the previously loaded portfolio, only the companies within data coverage, being Common Shares, Equities, and Companies within CORPS (Bonds). The overall product sustainability results from a rule of three of the sums of each company sustainability score times its weight times 100% of data coverage divided into the percentage those companies represent in the total amount of companies. The equations may be formalized as follows:

$$\frac{\begin{matrix}[ ( scoreA \times weightA ) + ( scoreB \times weightB ) + \\ ( scoreC \times weightC ) ] \times 100 \%\end{matrix}}{20 \%} \qquad [ Equation 7 ]$$

Formally defined, the equation would follow as:

$$Overall Product Sustainability = \frac{{\sum }_{i = 0}^{i = n} ( C {S}_{i} \times C {W}_{i} )}{P} \qquad [ Equation 8 ]$$

### Where:

“CS” refers to the company score;

“CW” represents the company weight;

“i” refers to the index variable that loops through the total amount of companies; and

“P” represents the percentage of companies within data coverage from the total amount of companies.

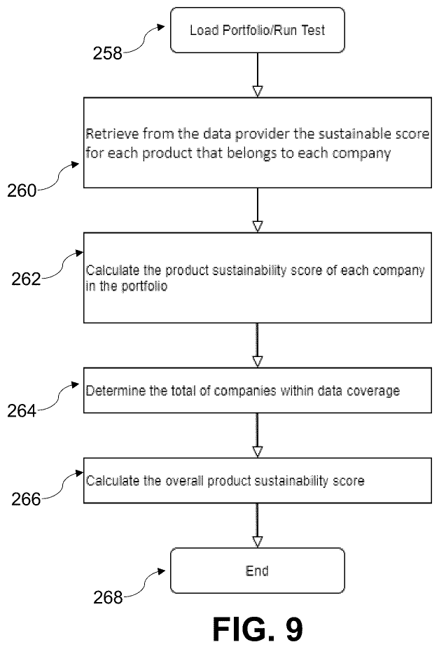

A product sustainability flowchart is depicted in FIG. 9. The flowchart of FIG. 9 begins at a process step 258 that includes loading the portfolio or running the test. A process step 260 follows the process step 258 and includes the engine 122 retrieving, from the data sources, the sustainable score for each product that belongs to each company. Next, a process step 262 follows the process step 260 and includes the engine 122 calculating the product sustainability score for each company in the portfolio.

A process step 264 follows the process step 262 and includes the engine 122 determining the total of companies within the data coverage. A process step 266 follows the process step 264 and includes the engine 122 calculating the overall product sustainability score. A process step 268 follows the process step 266 and concludes the method of FIG. 9.

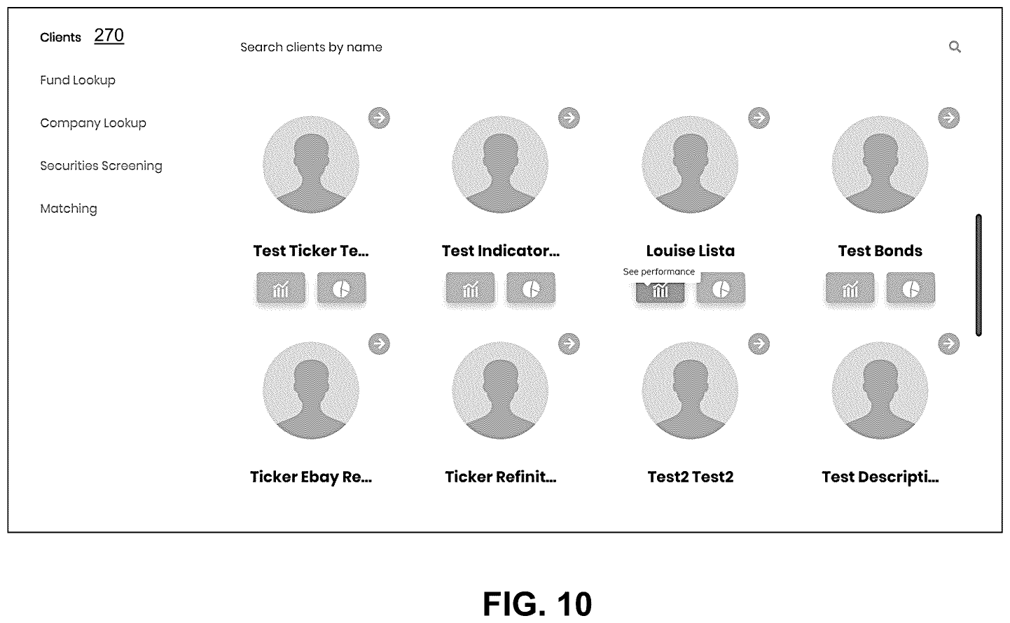

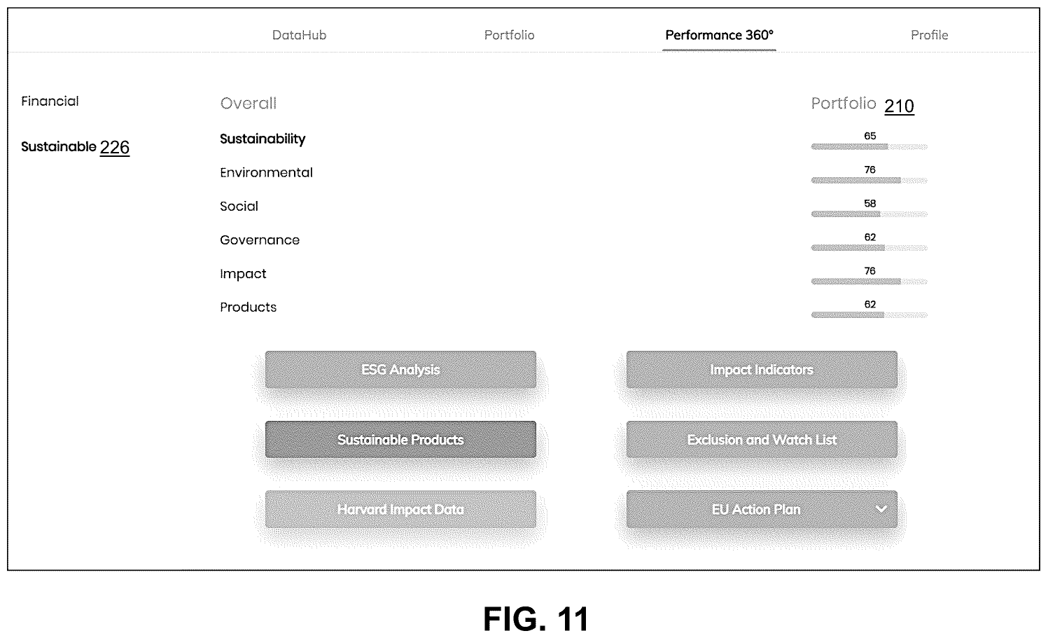

FIG. 10 depicts a schematic diagram showing profiles associated with clients 270 and FIG. 11 depicts a schematic diagram showing an overall sustainability 226, as well as an environmental criteria score, a social criteria score, a governance criteria score, an impact score, and a products score for a given portfolio 210.

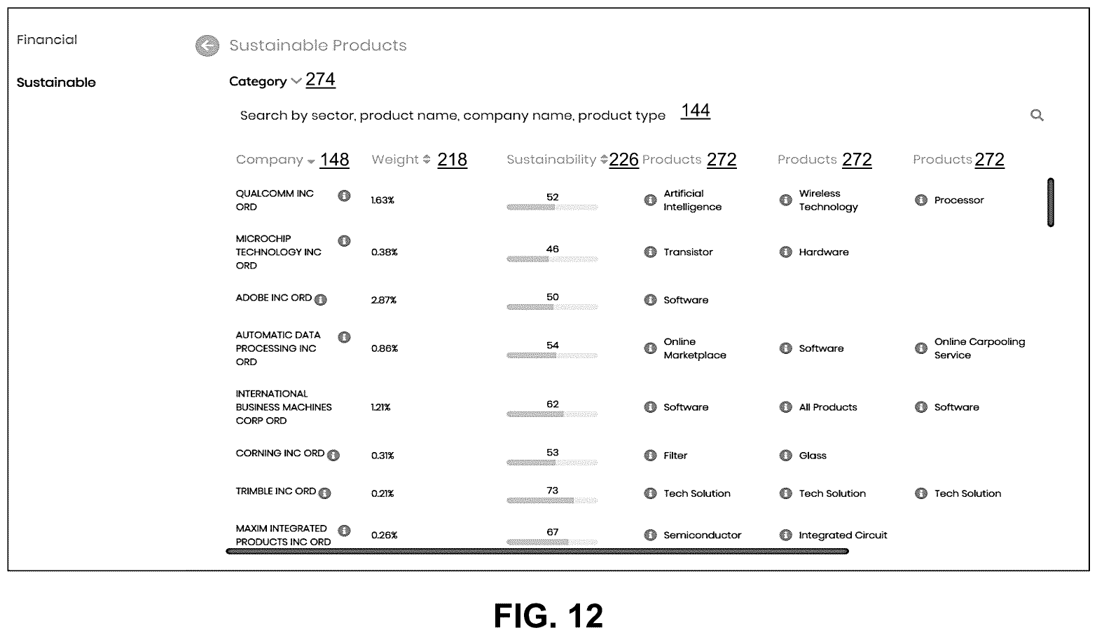

FIG. 12 depicts a schematic diagram showing various sustainable products for a given category 274. Specifically, FIG. 12 depicts products 272 associated with the given category 274, as well as a company 148 associated with the product 272, a weight 218 associated with the product 272, and a sustainability score 226 associated with the product 272. As shown in FIG. 12, the user is able to search 144 by sector, product name, company name, or product type.

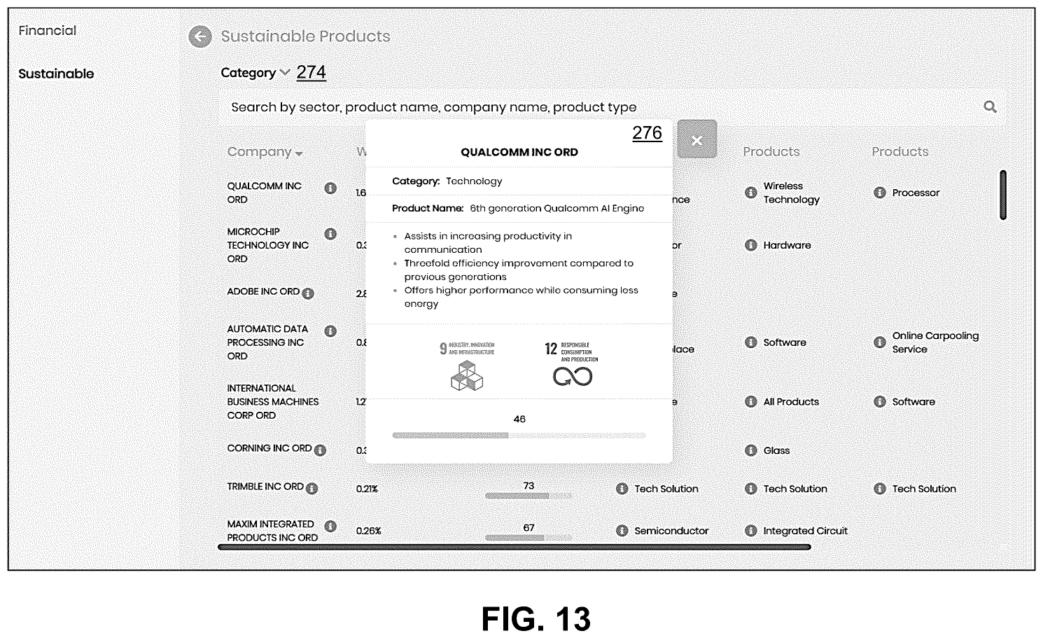

FIG. 13 depicts a schematic diagram showing an illustrative sustainable product profile 276, a category associated with the sustainable product, a company associated with the sustainable product, a product name associated with the sustainable product, information regarding the sustainable product, a sustainability score associated with the sustainable product, etc.

### Sustainable Products Scores Methodology

Two different levels of scoring may be used when it comes to impact products: (1) the product level and (2) the overall company level. The overall company level is just the average of the products scores, as demonstrated below in Equation 9.

(Sum of product scores)+No. of impact products [Equation 9]

The product scores may be calculated by the engine 122 through three different pillars: (1) scale of company impact, (2) product sustainability and relevance, and (3) product transparency. Each question receives its own individual score out of 100 and receives a final score in accordance with the weight given to it. The scale of company impact is determined by the in-house analysts' responses to the following question: Are the products found specific product/collections or more general data? Points are allocated based on the response to the question: (a) a ‘Unique Product’ receives 35 points, (b) a ‘Larger product’ category receives 50 points, and (c) ‘All products’ receives 100 points. This indicator has a weight of 32.5% and the score for this indicator is calculated by multiplying the weight by the points received for its answer, demonstrated below in Equation 10:

Points received×0.325=Score [Equation 10]

Product sustainability and Relevance are determined by the in-house analysts' responses to the following questions: ‘How sustainable is this product?’ and ‘How does this impact product fit into the rest of their product offerings?’. Points are allocated based on the response to each question. For ‘How sustainable is this product?’ the responses and points allocated are: (a) ‘Product is highly impactful across any industry, remarkable features' receives 100 points, (b) ‘Product is impactful, but more impressive within peer group than across' receives 80 points, (c) ‘Product has some impact features but the basic nature of the product is unsustainable’ receives 60 points, (d) ‘Product is impactful due to the scale of implementation’ receives 40 points, and (e) ‘Minimal/token efforts, it might be a stretch to consider this as an impact product’ receives 20 points. This indicator has a weight of 27.5% and the score for this indicator is calculated by multiplying the weight by the points received for its answer, demonstrated below in Equation 11:

Points received×0.275=Score [Equation 11]

For ‘How does this impact product fit into the rest of their product offerings?’ the responses and points allocated are: (a) ‘This is a main or flagship product for the company’ receives 100 points, (b) ‘This product fits in among other offerings by the company’ receives 50 points, and (c) ‘This product is an outlier’ receives 35 points. This indicator has a weight of 22.5% and the score for this indicator is calculated by multiplying the weight by the points received for its answer, demonstrated below in Equation 12:

Points received×0.225=Score [Equation 12]

Product Transparency is determined by the number of impact attribute bullet points filled out by the analyst. Points are allocated based on how many bullet points are filled (out of the three): (a) If a single bullet point is filled, 33 points are given, (b) If two bullet points are filled, 66 points are given, and (c) If three bullet points are filled, 100 points are given. This indicator has a weight of 17.5% and the score for this indicator is calculated by multiplying the weight by the points received for its answer, demonstrated below in Equation 13:

Points received×0.175=Score [Equation 13]

The sum of these indicator scores provides the final score for the product level. As demonstrated below in Equation 14:

(Points received×0.325)+(Points received×0.275)+(Points received×0.225)+(Points received×0.175)=Final Score [Equation 14]

An example for iPhone 8 is provided below in Table 5.

TABLE 5

| Bullet | Indicator | Score | Weighted | Final Score |
|---|---|---|---|---|
| A | Unique Product | 35 | 32.5% | 35*0.325 = |
| | | | | 11.375 |
| B1 | Product Highly | 100 | 27.5% | 100*0.275 = |
| | Impactful | | | 27.5 |
| B2 | Flagship Product | 100 | 22.5% | 100*0.225 = |
| | | | | 22.5 |
| C | 2 Description | 66 | 17.5% | 66*0.175 = |
| | Bullets filled | | | 11.55 |
| | | | | 72.925 |

### Impact Products—SDGs Normalization

Impact products are given a percentage to determine which of the SDGs they're most responsible for covering. Analysts initially provided a raw percentage to each impact product they concluded was the most accurate to that specific product. The final percentage, however, was determined using a premium multiplier. The purpose of the premium multiplier is to create lower values for SDGs that appear more frequently than others and to reward products that cover more unique SDGs that others don't cover. Multipliers may be determined through the following: (1) If the goal frequency is less than 5%, the multiplier is 2, (2) If the goal frequency is more than 5% but less than 10%, the multiplier is 0.7, (3) If the goal frequency is more than 10% but less than 20%, the multiplier is 0.5, and (4) If the goal frequency is more than 20%, the multiplier is 0.25.

Table 6 is provided below to make the distribution of multipliers more clear, and Table 7 is provided to show which multiplier each SDG was given:

TABLE 6

| % Alignment | Multiplier |
|---|---|
| <5% | 2 |
| >5% < 10% | 0.7 |
| >10% < 20% | 0.5 |
| >20% | 0.25 |

TABLE 7

| Weighting for SDG Premium | |
|---|---|
| (GOAL#) | Premium |
| 1 | 2.00 |
| 2 | 2.00 |
| 3 | 0.70 |
| 4 | 2.00 |
| 5 | 2.00 |
| 6 | 2.00 |
| 7 | 0.70 |
| 8 | 0.70 |
| 9 | 0.25 |
| 10 | 2.00 |
| 11 | 0.70 |
| 12 | 0.50 |
| 13 | 0.50 |
| 14 | 2.00 |
| 15 | 0.70 |
| 16 | 2.00 |
| 17 | 2.00 |

The weighted percentage for premium effect is calculated by multiplying the value with the premium multiplier it aligns with above, as demonstrated below:

Value*Premium Multiplier=% Weighted for Premium Effect [Equation 15]

The weighted percentage is then normalized by dividing the given percentage by the highest weighted percentage for premium effect value for that specific goal, as detailed below:

% Weighted for Premium Effect+Highest % Weighted for the SDG=Normalized % Weighted [Equation 16]

These are the calculations performed for SDG #1, for products with two SDGs a normalized weighted percentage is also given. However, it is found just by subtracting 100% by the normalized weighted percentage given to SDG #1, as demonstrated below:

100%−% Weighted for SDG #1=% Weighted for SDG #2 [Equation 17]

### Portfolio Creation

As described herein, the system aggregates ESG impact data, as well as sustainable product data, to create sustainable investment portfolios.

As described herein, a “portfolio” is a collection of financial investments like stocks, bonds, commodities, cash, and cash equivalents, including closed-end funds and exchange traded funds (ETFs). Every client/user 108 is the sole owner of the portfolio.

As described herein, a “weight” is a percentage of the investment made on a specifical item (e.g., fund).

As described herein, a “fund” is a portfolio of stocks, bonds, or other securities, usually overseen by a professional money manager.

As described herein, “holdings” are the contents of an investment portfolio held by an individual or an entity, such as a mutual fund or a pension fund. Portfolio holdings may encompass a wide range of investment products, including stocks, bonds, mutual funds, options, futures, and exchange traded funds (ETFs).

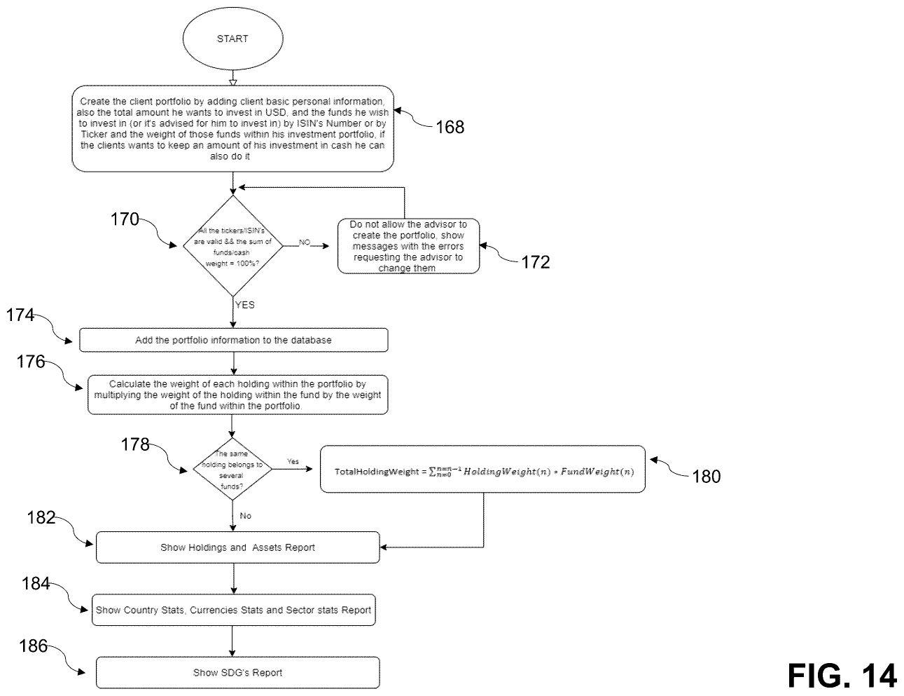

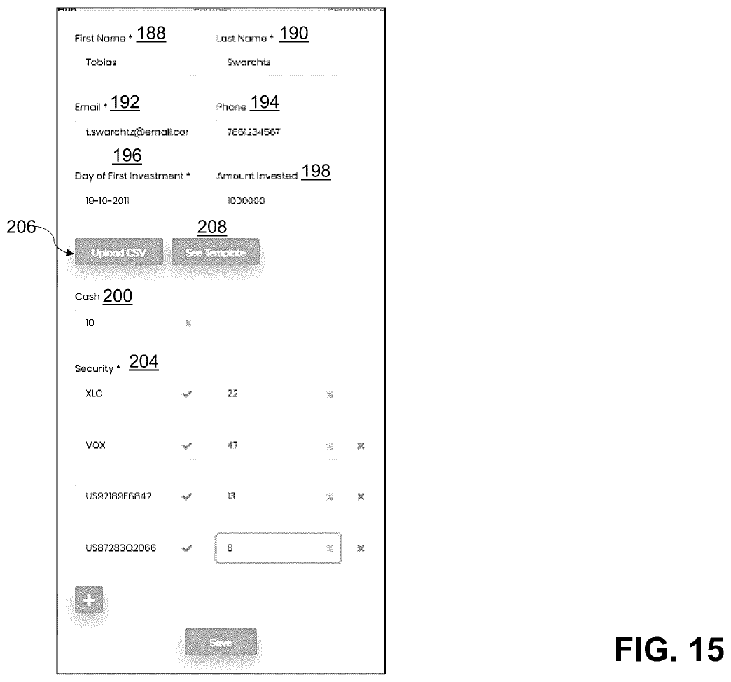

FIG. 14 depicts a flowchart for a portfolio creation process and FIG. 15 depicts a schematic diagram showing information entered by the user/client for portfolio creation. As shown in FIG. 14, a process step 168 occurs where the client portfolio is created by adding information, such as: client/user 108 basic information (e.g., a first name 188, a last name 190, an email address 192, a telephone number 194, a day of a first investment 196, etc.), a total monetary amount 188 that the client/user 108 wants to invest in U.S. dollars, funds that the user 108 wishes to invest in by ISIN number or ticker, weight of the funds within the investment portfolio, an indication if the user 108 wants to keep any amount 198 of the investment in cash, and securities and an associated percentage of the security 204. Further, as shown in FIG. 15, the user 108 may also upload a CSV file 206 and/or view a template 208.

A process step 170 of FIG. 14 follows the process step 168 and includes determining (1) if all of the tickers and/or ISIN numbers are valid and (2) if the sum of the funds and cash equal 100%. If a “NO” response follows the process step 170, a process step 172 occurs where a human advisor is prohibited from creating the portfolio. This process step also involves displaying messages/notifications with the errors and a request that the human advisor address the messages/notifications. If a “YES” response follows the process step 170, a process step 174 occurs where the portfolio information is saved and is added to the database (or server 112).

A process step 176 follows the process step 174 and includes calculating a weight of each holding within the portfolio by multiplying the weight of the holding within the fund by the weight of the fund within the portfolio. A process step 178 follows the process step 176 and includes determining if the same holding belongs to several funds. If a “YES” response follows the process step 178, a process step 180 occurs where Equation 20 is utilized. If a “NO” response follows the process step 178, a process step 182 occurs where the holdings and assets report is shown.

A process step 184 follows the process step 182 where a report showing country statistics, currency statistics, and sector statistics is shown. A process step 186 follows the process step 184 where an SDG report is shown. The process step 186 concludes the method of FIG. 14.

Specifically, the total value of the portfolio is equal to the sum of the value of all of the funds that belong to that portfolio, which is expressed formally in Equation 18.

Portfolioₓ=Σₙ₌₀^{n=y}FundWeight(n) [Equation 18]

### Where:

“x” is the Portfolio unique ID;

“y” is the amount of funds added to the portfolio;

“n” is the positional identifier for a given fund within the portfolio; and

“FundWeight” is the weight that was assigned to the fund by the in-house advisor at the moment of creating (or modifying) the portfolio.

The total weight of a holding within a portfolio is calculated by the product of the weight of the holding within the fund by the weight of the fund within the portfolio, which is expressed formally in Equation 19.

TotalHoldingWeightₓ=HoldingWeight*FundWeight [Equation 19]

If a holding is present in more than one fund, its total weight is equal to the sum of the product of the weight of the holding by the weight of every fund the holding belongs to, which is expressed formally in Equation 20.

TotalHoldingWeightₓ=Σₙ₌₀^{n=y}HoldingWeight(n)*FundWeight(n) [Equation 20]

### Where:

“x” is the Portfolio unique ID;

“y” is the amount of funds added to the portfolio;

“n” is the positional identifier for a given fund within the portfolio;

“TotalHoldingWeight” is the result of the sum of all the sub values;

“HoldingWeight” is the weight of the holding within a specific fund; and

“FundWeight” is the weight of a specific fund within the portfolio.

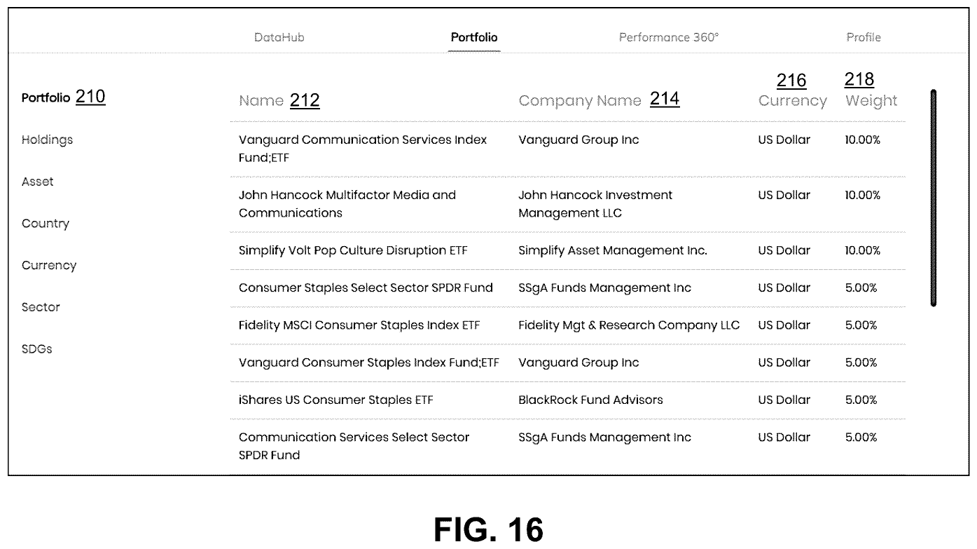

FIG. 16 depicts a schematic diagram showing an example portfolio 210. The portfolio 210 includes funds 212 (e.g., index funds, exchange-traded funds or ETF's, etc.), company names 214 associated with the funds 212, a form of currency (e.g., U.S. dollar) 216 invested in a given fund 212, and a weight 218 associated with each fund 212.

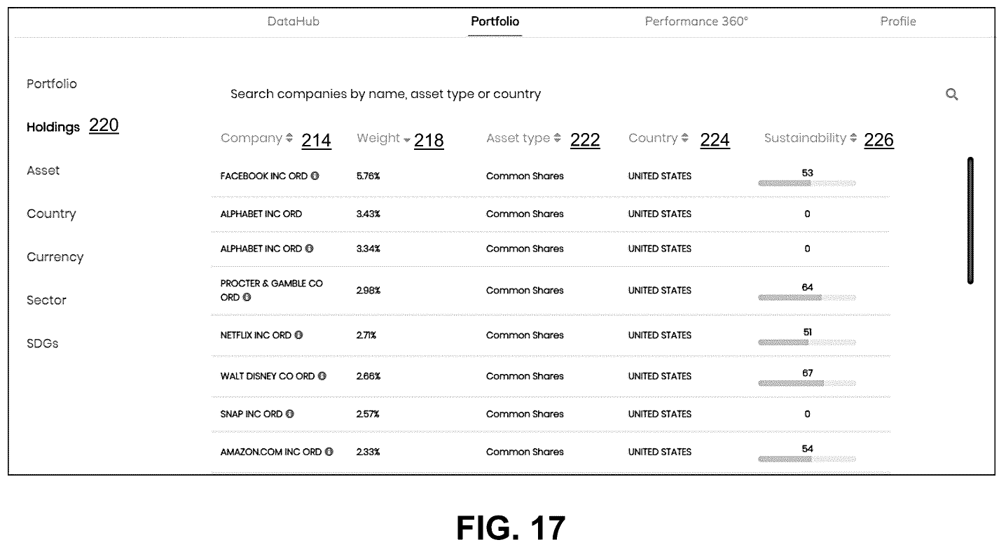

FIG. 17 depicts a schematic diagram showing example holdings 220. As shown in FIG. 17, a company name 214 associated with a given holding, a weight associated with each holding 218, an asset type (e.g., common shares) 222 associated with the given holding, a country 224 associated with a location of the company, and a sustainability score 226 may be shown.

### Rolling Performance Reports

As described herein, a “rolling performance report” is a graphical representation of the percentual variation of a stock price between the day and the previous day. The rolling performance report is automatically generated for each individual portfolio by the engine 122. For this report, “stock price” will be used to refer to the price of a stock reached after the closing of the markets on the dates of study.

To calculate the rolling performance, the price of a stock on two contiguous dates is considered. The formal expression of this calculation is shown in Equation 21.

$$RollingPerformance = \frac{\begin{matrix}{StockPrice}_{dateX} - \\ {StockPrice}_{dateX - 1}\end{matrix}}{{StockPrice}_{dateX - 1}} \qquad [ Equation 21 ]$$

As an illustrative example, take Oct. 21, 2021 as Date A and Oct. 22, 2021 as Date B. To calculate the rolling performance using Equation 21, the following is used:

$$RollingPerformance = \frac{{StockPrice}_{Date B} - {StockPrice}_{Date A}}{{StockPrice}_{Date A}}$$

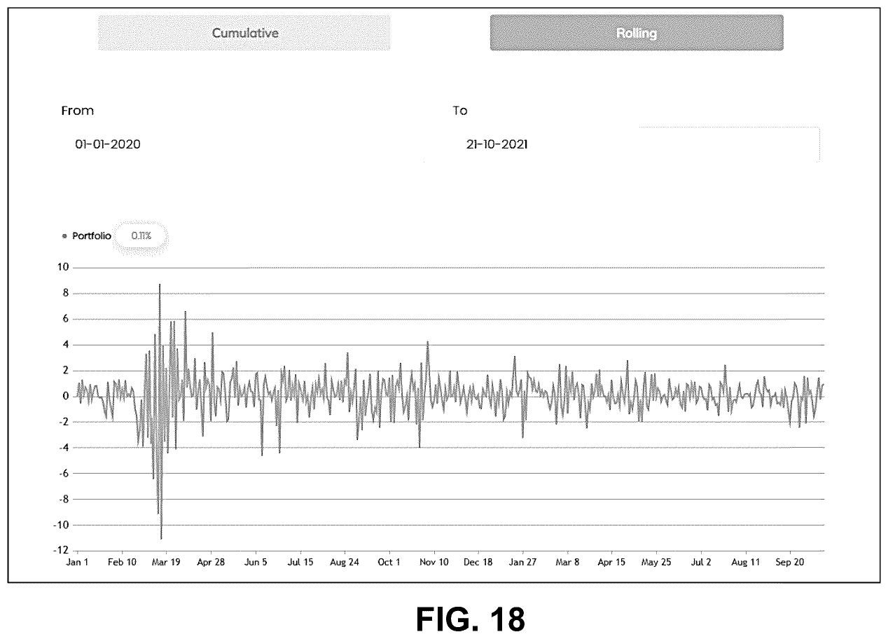

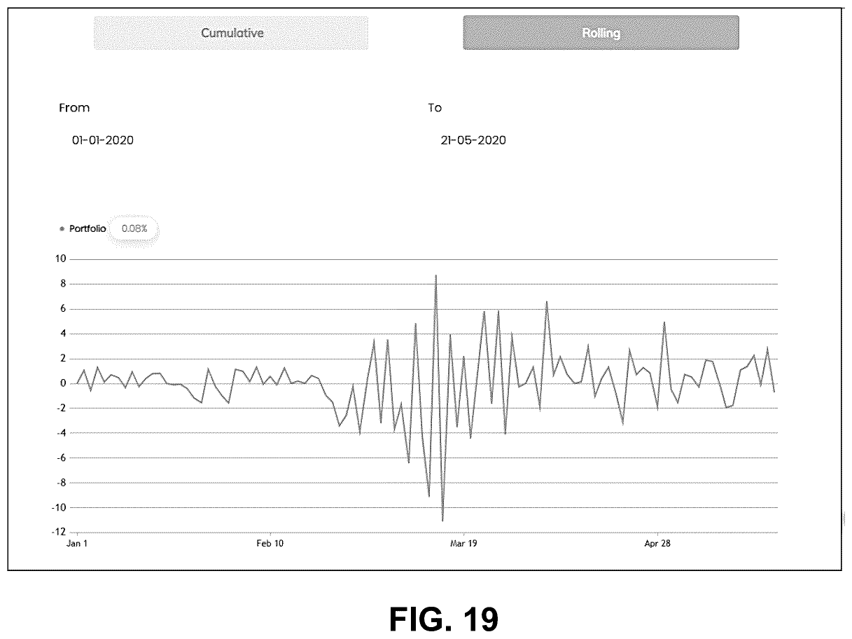

The sequence of result for this calculation of Equation 21 is presented on the sustainable wealth management platform 140 with a line diagram with the horizontal field representing all the dates from the time of the first investment to a date selected by the in-house advisor, and on the vertical plane a range of values going from −12 to 10, this is a percentual value referring to the variation mentioned before. Examples of this are depicted in FIG. 18 and FIG. 19. Specifically, FIG. 18 depicts a time frame of 22 months and 21 days and FIG. 19 depicts a time frame of 5 months and 21 days.

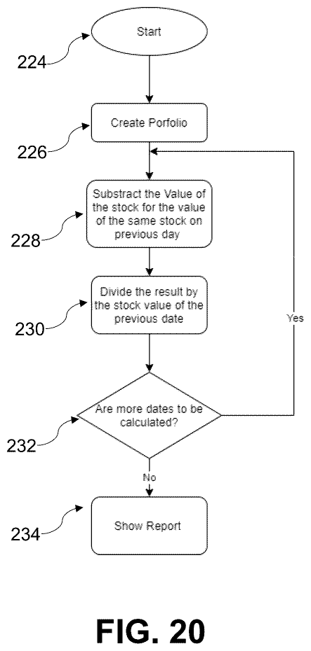

Moreover, FIG. 20 depicts a flowchart associated with data flow for the rolling performance report. Specifically, FIG. 20 begins at a process step 224 that is followed by a process step 226, which includes creating a portfolio. A process step 228 follows the process step 226 and includes subtracting the value of the stock for the value of the same stock on a previous day. A process step 230 follows the process step 228 and includes dividing the result of the process step 228 by the stock value of the previous day. A process step 232 follows the process step 230 and includes determining if more dates need to be calculated. A “YES” response or a “NO” response follows the process step 232. If the “YES” response follows the process step 232, the process moves to the process step 228. If the “NO” response follows the process step 232, a process step 234 occurs, where the report is shown. The process step 234 concludes the method of FIG. 20.

### Social Development Goals (SDGS) Reports

As described herein, “social development goals” or “SDGs” are a collection of 17 interlinked global goals designed to be a “blueprint to achieve a better and more sustainable future for all.” The SDGs were set up in 2015 by the United Nations General Assembly and are intended to be achieved by the year 2030.

As described herein, an “SDG report” is a report about the relationship between the client portfolio and all the UN's Social Development Goals adopted by all the United Nation Member States in 2015 as part of the 2030 Agenda for Sustainable Development. The SDG report is automatically generated by the engine 122 for each individual portfolio. The SDG report shows the list of the 17 UN approved icons for the goals and a percentage that represents the relation between the weight of the companies within the portfolio that invest toward that specific goal and the percentage of contribution every company has towards that specific goal.

For the SDG calculation, at a database level, every holding has associated ESG indicators and impact indicators, where each of these indicators may have up to two other indicators, if present, this indicator has a percentage associated that represents the percentage of contribution that the company does to that specific goal.

TABLE 8

| | Main | Percentage 1 | Secondary | Percentage 2 |
|---|---|---|---|---|
| ESG indicator | | | | |
| ESG indicator | 1 | 50% | 4 | 50% |
| code 1 | | | | |
| ESG indicator | 3 | 60% | 12 | 40% |
| code 2 | | | | |
| Impact indicator | | | | |
| Impact indicator | 5 | 50% | 8 | 50% |
| code 1 | | | | |
| Impact indicator | 7 | 70% | 13 | 30% |
| code 2 | | | | |

Table 8 depicts an example of two ESG Indicators and two impact indicators. As shown in Table 8, the “ESGIndicatorCode” and “ImpactIndicatorCode” are the unique identification for those specific indicator, the “main” column corresponds to the UN's Social Development Goals index and is a number between 1 and 17, the “percentage1” column is the percentage corresponding that index, the “secondary” column represents a second SDG index with the associated percentage in the “percentage2 column.”

Every holding on the portfolio may have an “n” number of indicators attached to it, so by applying distributive property, the sustainable wealth management platform 140 creates a relation between every holding, the weight and the weight of the SDG within the ESG and/or impact indicator.

Table 9 depicts an example of two companies within the portfolio, where the percentages shown represent the weight of the company within the portfolio they belong to.

TABLE 9

| Portfolio | |
|---|---|
| Company | Percentage |
| Apple | 20% |
| BMW | 5% |

Table 10 depicts an example of how the portfolio with the companies shown in Table 6 may look like.

TABLE 10

| | Holding | Weight | Main | Percentage 1 | Secondary | Percentage 2 |
|---|---|---|---|---|---|---|
| ESG indicator | | | | | | |
| ESG indicator code 1 | Apple | 20% | 1 | 50% | 4 | 50% |
| ESG indicator code 2 | BMW | 5% | 3 | 60% | 12 | 40% |
| Impact indicator | | | | | | |
| Impact indicator code 1 | Apple | 20% | 5 | 50% | 8 | 50% |
| Impact indicator code 2 | Apple | 20% | 7 | 30% | 13 | 70% |
| Impact indicator code 1 | BMW | 5% | 5 | 50% | 8 | 50% |

As shown, it is possible for the same company (e.g., Apple for this example) to have several indicators attached. The engine 122 may now proceed to normalize the data by applying the distributive property over the companies. Further, the primary and secondary indicators are split so its sorted on independent lines. Once every company with the weight of every SDG is sorted, the indicators code is no longer needed. Table 11 shows the resulting table of this process.

TABLE 11

| Holding | Weight | Number | Percentage |
|---|---|---|---|
| Apple | 20% | 1 | 50% |
| BMW | 5% | 3 | 60% |
| Apple | 20% | 4 | 50% |
| BMW | 5% | 12 | 40% |
| Apple | 20% | 5 | 50% |
| Apple | 20% | 7 | 30% |
| BMW | 5% | 5 | 50% |
| Apple | 20% | 8 | 50% |
| Apple | 20% | 13 | 70% |
| BMW | 5% | 8 | 50% |
| | | Percentage Sum | 500% |

On Table 11, “Weight” represents the total weight of the company for the portfolio, “Number” refers to the index of the UN's Social Development Goals, “Percentage” refers to the goal for that company within that indicator, and the “Percentages Sum” is the sum of all the percentages present on the list.

TABLE 12

| | | | | Percentage |
|---|---|---|---|---|
| Holding | Weight | Number | Percentage | Portfolio |
| Apple | 20% | 1 | 50% | 2 |
| BMW | 5% | 3 | 60% | 0.6 |
| Apple | 20% | 4 | 50% | 2 |
| BMW | 5% | 12 | 40% | 0.4 |
| Apple | 20% | 5 | 50% | 2 |
| Apple | 20% | 7 | 30% | 1.2 |
| BMW | 5% | 5 | 50% | 0.5 |
| Apple | 20% | 8 | 50% | 2 |
| Apple | 20% | 13 | 70% | 2.8 |
| BMW | 5% | 8 | 50% | 0.5 |
| | | Percentage | 500% | |
| | | Sum | | |

The engine 122 will proceed to calculate the “percentage portfolio” value for each element on the table, as shown on Table 12. The calculation occurs by dividing the percentage of the item by the Percentage Sum and multiplying this result by the weight. Then, the engine 122 proceeds to group the repeated SDG's by calculating the sum of the values and calculating the percentages that are located within the SDG's indicators present in the portfolio as shown on Table 13.

TABLE 13

| Number | Percentage Portfolio | SDG Percentage |
|---|---|---|
| 1 | 2 | 14.29 |
| 3 | 0.6 | 4.286 |
| 4 | 2 | 14.29 |
| 5 | 2.5 | 17.86 |
| 7 | 1.2 | 8.571 |
| 8 | 2.5 | 17.86 |
| 12 | 0.4 | 2.858 |
| 13 | 2.8 | 20 |
| Total | 14 | 100 |

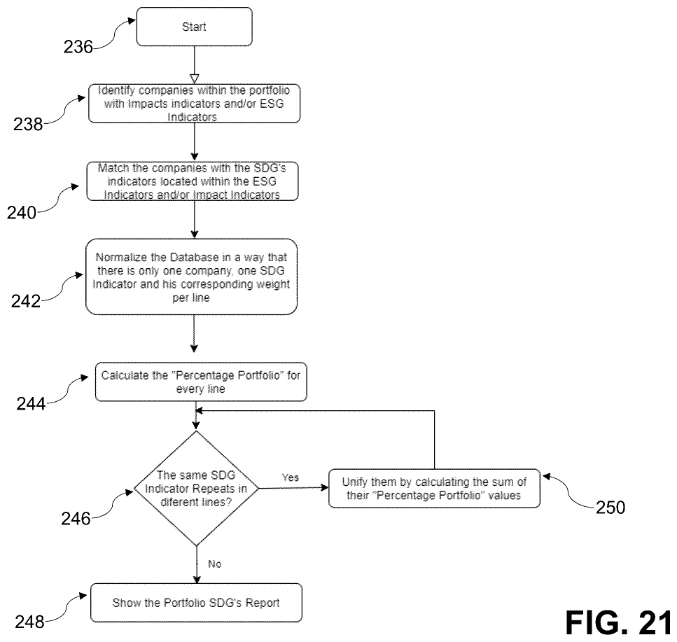

FIG. 21 depicts a flowchart associated with a method to display or show an SDG report for the portfolio. The method of FIG. 21 beings at a process step 236. The process step 236 is followed by a process step 238 that includes identifying companies within the portfolio that have impact indicators and/or ESG indicators. A process step 240 follows the process step 238 and includes matching the companies with the SDG indicators located within the ESG indicators and/or the impact indicators. A process step 242 follows the process step 240 and includes normalizing the database (or server 112) in a way that there is only one company, one SDG indicator and its corresponding weight per line.

A process step 244 follows the process step 242 and includes calculating a “percentage portfolio” for every line. A process step 246 follows the process step 244 and includes determining if the same SDG indicator repeats itself in different lines. If a “YES” response follows the process step 246, a process step 250 occurs where the SDG indicators are unified by calculating the sum of their “percentage portfolio” values. Once completed, the process step 250 then moves to the process step 246. If the “NO” response follows the process step 246, a process step 248 occurs where the SDG report for the portfolio is shown/displayed. The process step 248 concludes the method of FIG. 21.

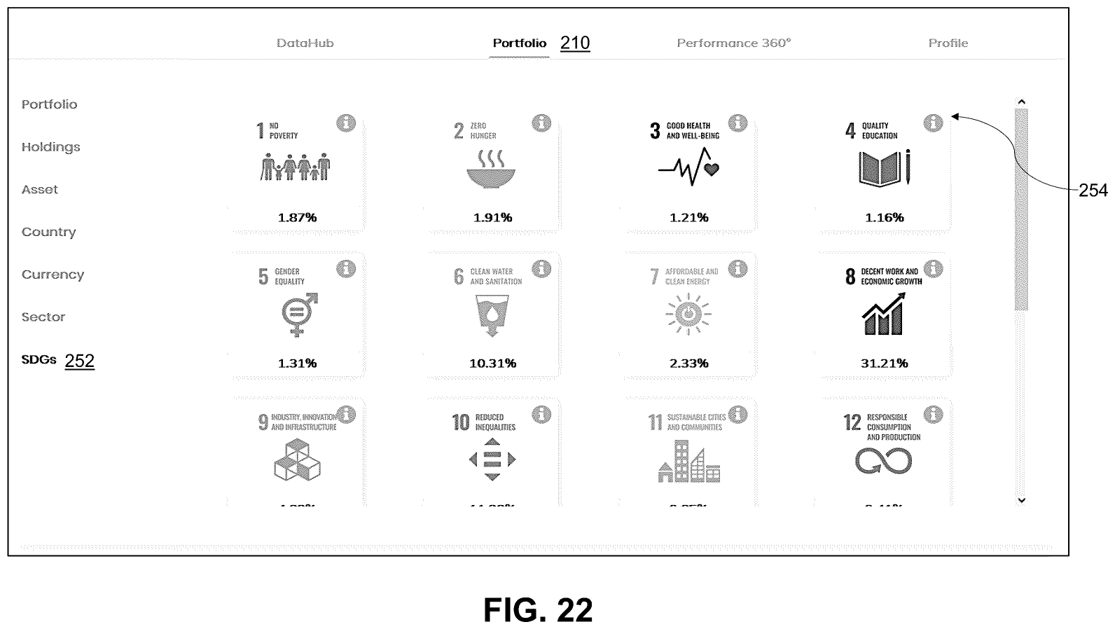

FIG. 22 depicts a schematic diagram showing an SDG report for the portfolio 210. For example, as shown in FIG. 22, the SDG report may depict the SDG's 252. Each SDG 252 may include text, graphics, and an SDG percentage, as shown in illustrative SDG 254 associated with “a quality education,” depicting a book graphic, and including the SDG percentage of 1.16%.

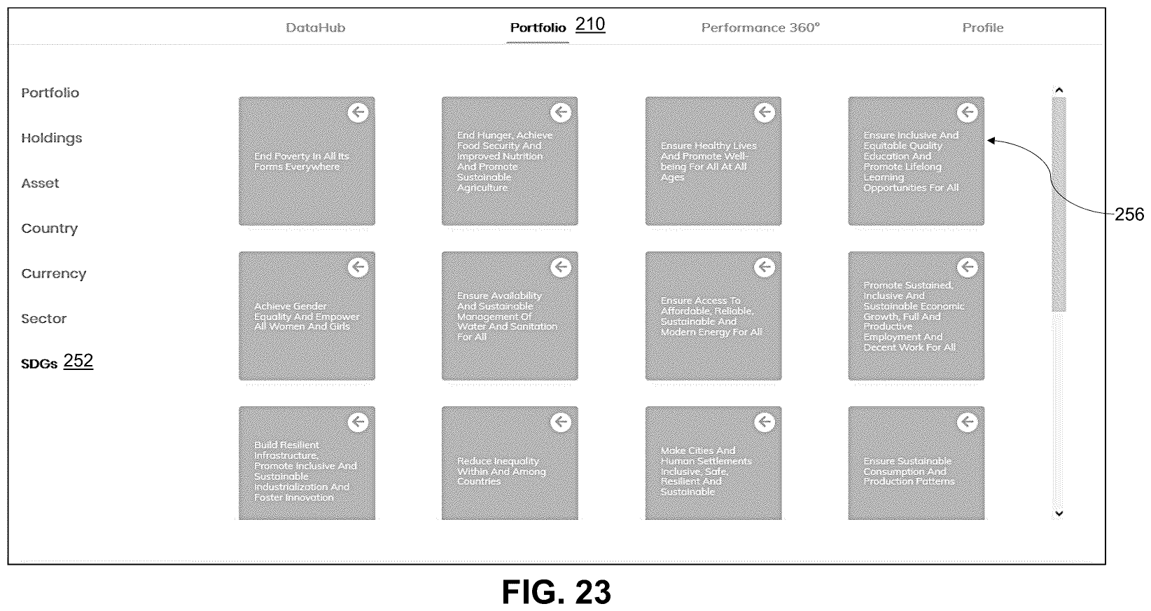

FIG. 23 depicts another schematic diagram showing an SDG report for the portfolio 210. For example, as shown in FIG. 23, the SDG report may depict the SDG's 252. As an illustrative example SDG 256, descriptive text is associated with the given SDG including “ensuring inclusive and equitable quality education and promote lifelong learning opportunities for all.”

### Computing Device

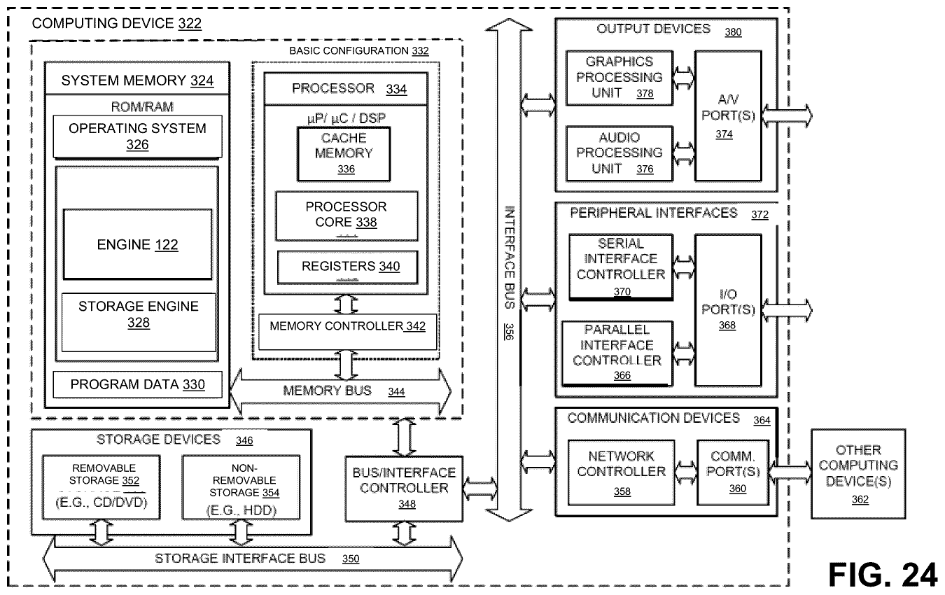

FIG. 24 depicts a block diagram of components of a computing device, according to at least some embodiments disclosed herein. In some embodiments, the present invention may be a computer system, a method, and/or the computing device 120 or the computing device 322 (of FIG. 24). For example, the computer system and/or the computing device 222 may be utilized to implement one or more methods described herein.

A basic configuration 332 of a computing device 322 is illustrated in FIG. 24 by those components within the inner dashed line. In the basic configuration 332 of the computing device 322, the computing device 322 includes a processor 334 and a system memory 324. In some examples, the computing device 322 may include one or more processors and the system memory 324. A memory bus 344 is used for communicating between the one or more processors 334 and the system memory 324.

Depending on the desired configuration, the processor 334 may be of any type, including, but not limited to, a microprocessor (P), a microcontroller (C), and a digital signal processor (DSP), or any combination thereof. Further, the processor 334 may include one more levels of caching, such as a level cache memory 336, a processor core 338, and registers 340, among other examples. The processor core 338 may include an arithmetic logic unit (ALU), a floating point unit (FPU), and/or a digital signal processing core (DSP Core), or any combination thereof. A memory controller 342 may be used with the processor 334, or, in some implementations, the memory controller 342 may be an internal part of the memory controller 342.

Depending on the desired configuration, the system memory 324 may be of any type, including, but not limited to, volatile memory (such as RAM), and/or non-volatile memory (such as ROM, flash memory, etc.), or any combination thereof. The system memory 324 includes an operating system 326, one or more engines, such as the engine 122, and program data 330. In some embodiments, the engine 122 may be an application, a software program, a service, or a software platform, as described infra. The system memory 324 may also include a storage engine 328 that may store any information disclosed herein.

Moreover, the computing device 322 may have additional features or functionality, and additional interfaces to facilitate communications between the basic configuration 332 and any desired devices and interfaces. For example, a bus/interface controller 348 is used to facilitate communications between the basic configuration 332 and data storage devices 346 via a storage interface bus 350. The data storage devices 346 may be one or more removable storage devices 352, one or more non-removable storage devices 354, or a combination thereof. Examples of the one or more removable storage devices 352 and the one or more non-removable storage devices 354 include magnetic disk devices (such as flexible disk drives and hard-disk drives (HDD)), optical disk drives (such as compact disk (CD) drives or digital versatile disk (DVD) drives), solid state drives (SSD), and tape drives, among others.

In some embodiments, an interface bus 356 facilitates communication from various interface devices (e.g., one or more output devices 380, one or more peripheral interfaces 372, and one or more communication devices 364) to the basic configuration 332 via the bus/interface controller 356. Some of the one or more output devices 380 include a graphics processing unit 378 and an audio processing unit 376, which are configured to communicate to various external devices, such as a display or speakers, via one or more A/V ports 374.

The one or more peripheral interfaces 372 may include a serial interface controller 370 or a parallel interface controller 366, which are configured to communicate with external devices, such as input devices (e.g., a keyboard, a mouse, a pen, a voice input device, or a touch input device, etc.) or other peripheral devices (e.g., a printer or a scanner, etc.) via one or more I/O ports 368.

Further, the one or more communication devices 364 may include a network controller 358, which is arranged to facilitate communication with one or more other computing devices 362 over a network communication link via one or more communication ports 360. The one or more other computing devices 362 include servers, the database, mobile devices, and comparable devices.

The network communication link is an example of a communication media. The communication media are typically embodied by the computer-readable instructions, data structures, program modules, or other data in a modulated data signal, such as a carrier wave or other transport mechanism, and include any information delivery media. A “modulated data signal” is a signal that has one or more of its characteristics set or changed in such a manner as to encode information in the signal. By way of example, and not limitation, the communication media may include wired media (such as a wired network or direct-wired connection) and wireless media (such as acoustic, radio frequency (RF), microwave, infrared (IR), and other wireless media). The term “computer-readable media,” as used herein, includes both storage media and communication media.

It should be appreciated that the system memory 324, the one or more removable storage devices 352, and the one or more non-removable storage devices 354 are examples of the computer-readable storage media. The computer-readable storage media is a tangible device that can retain and store instructions (e.g., program code) for use by an instruction execution device (e.g., the computing device 322). Any such, computer storage media is part of the computing device 322.

The computer readable storage media/medium can be a tangible device that can retain and store instructions for use by an instruction execution device. The computer readable storage media/medium may be, for example, but is not limited to, an electronic storage device, a magnetic storage device, an optical storage device, an electromagnetic storage device, and/or a semiconductor storage device, or any suitable combination of the foregoing. A non-exhaustive list of more specific examples of the computer readable storage media/medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and/or a mechanically encoded device (such as punch-cards or raised structures in a groove having instructions recorded thereon), and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Aspects of the present invention are described herein regarding illustrations and/or block diagrams of methods, computer systems, and computing devices according to embodiments of the invention. It will be understood that each block in the block diagrams, and combinations of the blocks, can be implemented by the computer-readable instructions (e.g., the program code).

The computer-readable instructions are provided to the processor 334 of a general purpose computer, special purpose computer, or other programmable data processing apparatus (e.g., the computing device 322) to produce a machine, such that the instructions, which execute via the processor 334 of the computer or other programmable data processing apparatus, create means for implementing the functions/acts specified in the block diagram blocks. These computer-readable instructions are also stored in a computer-readable storage medium that can direct a computer, a programmable data processing apparatus, and/or other devices to function in a particular manner, such that the computer-readable storage medium having instructions stored therein comprises an article of manufacture including instructions, which implement aspects of the functions/acts specified in the block diagram blocks.

The computer-readable instructions (e.g., the program code) are also loaded onto a computer (e.g. the computing device 322), another programmable data processing apparatus, or another device to cause a series of operational steps to be performed on the computer, the other programmable apparatus, or the other device to produce a computer implemented process, such that the instructions, which execute on the computer, the other programmable apparatus, or the other device, implement the functions/acts specified in the block diagram blocks.

Computer readable program instructions described herein can also be downloaded to respective computing/processing devices from a computer readable storage medium or to an external computer or external storage device via a network (e.g., the Internet, a local area network, a wide area network, and/or a wireless network). The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer/computing device, partly on the user's computer/computing device, as a stand-alone software package, partly on the user's computer/computing device and partly on a remote computer/computing device or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to block diagrams of methods, computer systems, and computing devices according to embodiments of the invention. It will be understood that each block and combinations of blocks in the diagrams, can be implemented by the computer readable program instructions.

The block diagrams in the Figures illustrate the architecture, functionality, and operation of possible implementations of computer systems, methods, and computing devices according to various embodiments of the present invention. In this regard, each block in the block diagrams may represent a module, a segment, or a portion of executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block and combinations of blocks can be implemented by special purpose hardware-based systems that perform the specified functions or acts or carry out combinations of special purpose hardware and computer instructions.

Another embodiment of the invention provides a method that performs the process steps on a subscription, advertising, and/or fee basis. That is, a service provider can offer to assist in method steps described herein. In this case, the service provider can create, maintain, and/or support, etc. a computer infrastructure that performs the process steps for one or more customers. In return, the service provider can receive payment from the customer(s) under a subscription and/or fee agreement, and/or the service provider can receive payment from the sale of advertising content to one or more third parties.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

When introducing elements of the present disclosure or the embodiments thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A method executed by an engine of a computing device for aggregating environmental, social, and governance (ESG) impact data and sustainable product data for sustainable investment portfolios, the method comprising:
collecting ESG impact data and sustainable product data from external data sources;
aggregating the ESG impact data and the sustainable product data;
transferring the aggregated data to a sustainable wealth management platform; and
providing access to a user to interact with the sustainable wealth management platform to track, measure, and understand an impact of an investment in a sustainable investment portfolio.

2. The method of claim 1, further comprising:
determining an inability to locate the ESG impact data and the sustainable product data from the external data sources; and
prompting a human analyst to remedy any deficiencies.

3. The method of claim 1, wherein the aggregating the ESG impact data and the sustainable product data occurs via an artificial intelligence algorithm of the engine.

4. The method of claim 1, wherein the sustainable wealth management platform comprises a lookup tool, and wherein the method further comprises:
receiving, from the user via the lookup tool, at least a date of the user's first investment, a ticker symbol or ISIN of a holding within the sustainable investment portfolio, and a weight of the holding within the sustainable investment portfolio;
creating an individualized report of a financial performance and a sustainable performance of the sustainable investment portfolio; and
displaying the individualized report via a graphical user interface (GUI) of the computing device to the user.

5. The method of claim 1, wherein the sustainable wealth management platform comprises a screening tool, and wherein the method further comprises:
receiving, from the user via the screening tool, an input, wherein the input comprises at least one of: fund financial or sustainable criteria, company financial or sustainable criteria, and country financial or sustainable criteria;
identifying a list of funds, companies, or countries that match the input;
displaying the identified list to the user via a graphical user interface (GUI) of the computing device; and
allowing the user to export the identified list.

6. The method of claim 5, wherein the fund financial or sustainable criteria is selected from the group consisting of: a fund type, an asset manager, and a controversy.

7. The method of claim 5, wherein the company financial or sustainable criteria is selected from the group consisting of: a region, a sector, and an industry.

8. The method of claim 5, wherein the country financial or sustainable criteria is selected from the group consisting of: a region, a sustainable performance, and an exclusion.

9. The method of claim 1, wherein the sustainable wealth management platform comprises a matching tool, and wherein the method further comprises:
receiving, from the user via the matching tool, an input, wherein the input is selected from the group consisting of: investment goals of the user, an income of the user, an initial investment amount for the user, a monthly contribution amount for the user, and a risk tolerance associated with the user;
prompting the user to select one or more sustainable development goals;
determining funds that match the input and the one or more sustainable development goals of the user;
automatically displaying a model sustainable investment portfolio comprising the funds via a graphical user interface (GUI) of the computing device; and
allowing the user to export the model.

10. The method of claim 1, wherein the sustainable wealth management platform comprises a portfolio sharing tool, and wherein the method further comprises generating a shareable link that allows the user to view and share the sustainable investment portfolio.

11. A computer system configured to aggregate environmental, social, and governance (ESG) impact data and sustainable product data for sustainable investment portfolios, the computer system comprising:
one or more external data sources;
a computing device comprising at least a graphical user interface (GUI) and an engine, wherein the engine comprises at least one algorithm, and wherein the engine is configured to:
collect ESG impact data and sustainable product data from the one or more external data sources;
aggregate the ESG impact data and the sustainable product data;
transfer the aggregated data to a sustainable wealth management platform; and
provide access to a user to interact with one or more tools of the sustainable wealth management platform to track, measure, and understand an impact of an investment in a sustainable investment portfolio;
a database or repository configured to store the aggregated data and the sustainable investment portfolio; and
the sustainable wealth management platform comprising at least:
a lookup tool configured to:
receive, from the user, at least a date of the user's first investment, a ticker symbol or ISIN of a holding within the sustainable investment portfolio, and a weight of the holding within the sustainable investment portfolio;
create an individualized report of a financial performance and a sustainable performance of the sustainable investment portfolio; and
display the individualized report via the GUI;
a screening tool configured to:
receive, from the user, an input, wherein the input comprises at least one of: fund financial or sustainable criteria, company financial or sustainable criteria, and country financial or sustainable criteria;
identify a list of funds, companies, or countries that match the input; and
display the identified list to the user via the GUI; and
a matching tool configured to:
receive, from the user, an input, wherein the input is selected from the group consisting of: investment goals of the user, an income of the user, an initial investment amount for the user, a monthly contribution amount for the user, and a risk tolerance associated with the user;
prompt the user to select one or more sustainable development goals;
determine funds that match the input and the one or more sustainable development goals of the user; and
automatically display a model sustainable investment portfolio comprising the funds via the GUI.

12. The computer system of claim 11, wherein the engine is further configured to:
identify each company within the sustainable investment portfolio;
match each company with one or more indicators on an exclusion and watch list;
in response to a determination that a company is involved in an entirety of the one or more indicators on the exclusion and watch list, assign a first indicator to the company;
in response to a determination that the company is not involved in the entirety of the one or more indicators on the exclusion and watch list,
determine if the company is involved with at least one of the one or more indicators on the exclusion and watch list;
in response to a determination that the company is involved with the at least one of the one or more indicators on the exclusion and watch list, assign a second indicator to the company; and
in response to a determination that the company is not involved with the at least one of the one or more indicators on the exclusion and watch list, assign a third indicator to the company.

13. The computer system of claim 12, wherein each of the first indicator, the second indicator, and the third indicator differ.

14. The computer system of claim 12, wherein each indicator of the one or more indicators on the exclusion and watch list are selected from the group consisting of: abortifacients, adult entertainment, adult entertainment revenue, alcohol, alcohol revenue, animal testing, animal welfare, civilian firearms, civilian firearms revenue, contraceptives, fossil fuels, gambling, gambling revenue, genetically modified organisms (GMOs), united nations (UN) international labor organization (ILO), military weapons, military weapons revenue, nuclear energy, nuclear energy revenue, pesticides, pork products, stem cell research, tobacco, tobacco revenue, UN global compact, climate, waste, toxic, water, human rights, child labor, employees, diversity, employees health & safety, privacy, marketing, anti-competitions practices, corruption and fraud, and product quality.

15. The computer system of claim 11, wherein the engine is further configured to:
retrieve, from the database or the repository, a sustainable score for each product that belongs to each company in the sustainable investment portfolio;
calculate a product sustainability score for each company; and
calculate an overall sustainability score for each company.

16. The computer system of claim 11, wherein the engine is further configured to:
receive information from the user, wherein the information is selected from the group consisting of: a first name of the user, a last name of the user, an email address associated with the user, a telephone number associated with the user, a date of a first investment by the user, a total monetary amount that the user wants to invest in U.S. dollars, funds that the user wishes to invest in by ISIN number or ticker, a weight of the funds within the investment portfolio, an indication if the user wants to keep any amount of the investment in cash, and securities and an associated percentage of the security; and
determine if the ISIN number or the ticker is valid and if a sum of the funds and the cash equal 100%.

17. The computer system of claim 16, wherein, in response to a determination that the ISIN number or the ticker is invalid and the funds and the cash fail to equals 100%, the engine is further configured to:
transmit the information for verification and correction and provides an error message to the user identifying the error and prohibits the creation of the sustainable investment portfolio.

18. The computer system of claim 16, wherein, in response to a determination that the ISIN number or the ticker is valid and the funds and the cash equals 100%, the engine is further configured to:
save the information in the sustainable investment portfolio;
add the sustainable investment portfolio to the database or the repository;
calculate a weight of each holding within the sustainable investment portfolio by multiplying a weight of a holding within a fund by a weight of the fund within the sustainable investment portfolio; and
determine if the same holding belongs to at least two funds.

19. The computer system of claim 18, wherein, in response to a determination that the same holding belongs to the at least two funds, utilizing an equation:
TotalHoldingWeightₓ=Σₙ₌₀^{n=y}HoldingWeight(n)*FundWeight(n),
wherein:
“x” is the Portfolio unique ID;
“y” is the amount of funds added to the portfolio;
“n” is the positional identifier for a given fund within the portfolio;
“TotalHoldingWeight” is the result of the sum of all the sub values;
“HoldingWeight” is the weight of the holding within a specific fund; and
“FundWeight” is the weight of a specific fund within the portfolio.

20. The computer system of claim 18, wherein, in response to a determination that the same holding fails to belong to the at least two funds, display a holdings and assets report, a report showing country statistics, currency statistics, and sector statistics, and an SDG report via the GUI.
